(19) United States
(12) Patent Application Publication
(10) Pub. No.: US 2024/0288929 A1
(43) Pub. Date: Aug. 29, 2024

(54) METHODS AND SYSTEMS FOR DETERMINING USER INTEREST RELEVANT TO CO-LOCATED USERS

(71) Applicant: Adeia Guides Inc., San Jose, CA (US)

(72) Inventors: Johan Kölhi, Vaxholm (SE); Anthony Friede, Upplands Väsby (SE)

(21) Appl. No.: 18/114,529

(22) Filed: Feb. 27, 2023

(51) Int. Cl. G06F 3/01; H04W 4/02; H04W 8/20

(52) U.S. Cl. CPC G06F 3/011; H04W 4/02; H04W 8/20

(57) ABSTRACT

Systems and methods are described for controlling a user device. Such methods and system may obtain, via an extended reality (XR) headset, a biometric response of a first user, determine, based on obtained location data, a location of the first user, and obtain, via a user device associated with a second user, a location of the second user. Methods and system may determine, using control circuitry, that the first user and the second user are co-located based on the location of the first user and the location of the second user, and, responsive to determining the first user and the second user are co located, determine, using control circuitry, a particular interest of the first user based on the biometric response of the first user. The methods and system may then generate, using control circuitry and based on determining the particular interest, a user notification indicating a presence of the first user.

### BACKGROUND

The general concept of matching applications and services have been in existence for some time. However, these applications and services may provide limited scope for interactivity and user engagement.

It will be understood that improvements in matching applications and services are desirable.

### SUMMARY

Disclosed embodiments relate to methods and systems for combining augmented reality (AR), location services, and environmental and biometric sensing into entirely new functionalities capable of enabling and extending the capabilities of next-generation matching services. These new functionalities enable increased security via secure verification of each user's physical location and local environment, as well as via secure identification and verification of the identify of each user to the other. This disclosure presents new methods for identifying and confirming a level of interest between individuals and opens up the possibility for crowd-based information and support to be available to each matched person in location in real time. Some embodiments may include the ability to account for a person's prior history, reputation, movement and behavior patterns (e.g., when providing recommendations for suggesting proactive introductions between different users).

In an embodiment, one or more disclosed techniques enable a system to detect not only that two or more people are co-located in a physical space, but that one of these people is expressing a biometric response (e.g., gaze, increased heartrate, increased perspiration, etc.) indicating an interest in one or more of the other co-located people. This interest may be detected via a wearable mobile device, such as an extended reality (XR) headset or smartwatch. When this interested is detected, the other person (or people) of interest may be notified to facilitate matchmaking.

In some embodiments, the systems and methods described herein combine multiple levels of identity verification and interest verification through server-side, device-side and collaborative identification protocols.

Systems and methods are provided herein for controlling a user device comprising: obtaining, via an XR headset, a biometric response of a first user. The systems and methods further comprise: determining, based on obtained location data, a location of the first user. The systems and methods further comprise: obtaining, via a user device associated with a second user, a location of the second user. The systems and methods further comprise: determining, using control circuitry, that the first user and the second user are co-located based on the location of the first user and the location of the second user. The systems and method further comprise: responsive to determining the first user and the second user are co-located, determining, using control circuitry, a particular interest of the first user based on the biometric response of the first user. The systems and methods further comprise: generating, using control circuitry and based on determining the particular interest, a user notification indicating a presence of the first user.

According to some examples of the systems and methods provided herein, the location of the first user and the location of the second user each comprise global positioning system (GPS) data and/or wireless network data. Determining that the first user and second user are co-located may comprise comparing, using control circuitry, the location of the second user to the location of the first user, and verifying, using control circuitry, that the first user and the second user are co-located when the location of the second user and the location of the first user substantially correspond.

According to some examples of the systems and methods provided herein, the location of the first user and the location of the second user each comprise auditory data and/or photographic data. Determining that the first user and second user are co-located may comprise comparing, using control circuitry, the location of the second user to the location of the first user, and verifying, using control circuitry, that the first user and the second user are co-located when the location of the second user and the location of the first user substantially correspond.

In some examples, other profile data associated with another user of a corresponding other user device may be obtained. The other profile data may comprise a location of the other user. The other user may be a different user to the first user and the second user. The systems and method may further comprise comparing, using control circuitry, the location of the other user to the location of the first user and the location of the second user to determine that the location of the other user substantially corresponds to the location of the first user and the location of the second user and that the other user is co-located with the first and second users. The systems and method may further comprise verifying, using control circuitry, that the first user and the second user are co-located in response to determining that the other user is co-located with the first and second users.

In some examples, the systems and methods may further comprise obtaining profile data associated with the second user. The profile data may comprise the location of the second user or data useable to determine, estimate, or verify a location or approximate location of the second user. In some instances, a location of the second user is determined, at least in part, by determining a location of a device of the second user (e.g., an XR headset, a phone, a smart wearable device, etc.).

According to some examples of the systems and methods provided herein, the profile data associated with the second user further comprises identification data associated with the second user, and the method further comprises obtaining, from an environment in which the first user is located, situational data, comparing, using control circuitry, the identification data associated with the second user to the situational data, and verifying, using control circuitry, an identity of the second user when the identification data associated with the second user and the situational data substantially correspond.

In some examples, the identification data associated with the second user and/or the situational data each comprise at least one of: biometric data, wireless network data, auditory data, or photographic data.

According to some examples of the systems and methods provided herein, other profile data associated with another user of a corresponding other user device may be obtained, wherein the other profile data comprises identification data associated with the other user, and the other user is a different user to the first user and the second user, comparing, using control circuitry, the situational data to the identification data associated with the other user and the identification data associated with the second user, and verifying, using control circuitry, the identity of the second user when the situational data substantially corresponds to the identification data associated with the other user and the identification data associated with the second user.

In some examples, determining the particular interest of the first user comprises comparing, using control circuitry, the biometric response of the first user to a threshold, and identifying, using control circuitry, the particular interest if the biometric response meets the threshold.

According to some examples of the systems and methods provided herein, a distance between the first user and the second user based on the location data of the first user and the location data of the second user may be determined, and if the first user is within a predetermined distance of the second user based on the determined distance, only upon determining the first user is located within a predetermined distance of the second user, determining, using control circuitry, the particular interest of the first user.

In some examples of the systems and methods provided herein, the particular interest of the first user indicates the first user is attracted to the second user based on the biometric response of the first user, and the user notification further indicates the first user is attracted to the second user.

In some examples, the method further comprises transmitting to the user device associated with the second user, using control circuitry, the user notification indicating the presence of the first user and indicating the first user is attracted to the second user.

In some embodiments, a system may determine a user's interest in a co-located second user based on a measured biometric response of the first user and a mutual particular interest. For instance, the system may obtain first user data for a first user (e.g., a user profile), biometric user data measured by, e.g., a biometric sensor, a second user profile for a second user, and location data for each of the first user and the second user. The system may determine the first user and the second user are at the same location (e.g., within a threshold), determine whether the biometric user data indicates interest, and determine whether the first user data and the second user profile indicate a common interest between the first user and second user. In some embodiments, a notification may be presented based on, e.g., the determination that there is a common interest between the first user and second user, the determination that the first user and second user are co-located, and/or the determination that the biometric user data indicates interest.

In some embodiments, a system may determine a user's interest in a second person at the same location based on eye-tracking and/or head position of the first user in relation to a second user using an AR, virtual reality (VR), and/or extended reality (XR) device. For instance, the system may obtain first user data for a first user (e.g., a user profile), gaze and/or head position data measured by, e.g., the AR/VR/XR device, a second user profile for a second user, and location data for each of the first user and the second user. In some instances, gaze is tracked by tracking pupil locations and, for example, one or more facial features, enabling the system to determine a gaze (e.g., a line or vector extending from the center of the tracked features) that is independent of head pose. In some instances, gaze is tracked by tracking head pose a using the head pose as a proxy for gaze (e.g., where the user is generally assumed to be looking straight forward relative to head pose, rather than glancing up, down, or sideways). In some instances, the system determines by head pose and pupil location to determine gaze. In any event, the system may determine the first user and the second user are at the same location (i.e., co-located), determine whether the first user's gaze and/or head position data indicates the first user has seen the second user, and determine whether the first user data and the second user profile indicate a common interest between the first user and second user. In some embodiments, a notification may be presented based on, e.g., the determination that there is a common interest between the first user and second user, the determination that the first user and second user are co-located, and/or the determination that the first user's head position data indicates the first user saw the second user.

In some embodiments, a system may determine a user's interest in a second person at the same location based on eye-tracking and/or head position of the first user in relation to a second user using an AR, VR, and/or XR device with biometric response data for the first user. For instance, the system may obtain first user data for a first user (e.g., a user profile), biometric user data measured by, e.g., a biometric sensor, gaze and/or head position data measured by, e.g., the AR/VR/XR device, a second user profile for a second user, and location data for each of the first user and the second user. The system may determine the first user and the second user are at the same location, determine whether the first user's gaze and/or head position data indicates the first user has seen the second user, and determine whether the biometric user data indicates interest. In some embodiments, a notification may be presented based on, e.g., the determination that the first user and second user are co-located, determination that the biometric user data indicates interest, and/or the determination that the first user's head position data indicates the first user saw the second user.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a system for controlling a user device based on information received, in accordance with some examples of the disclosure;

FIG. 2 illustrates an overview of a system for controlling a user device based on information received, in accordance with some examples of the disclosure;

FIG. 3 a block diagram showing components of an exemplary system for controlling a user device based on information received, in accordance with some examples of the disclosure;

FIG. 4 is a flowchart representing a process for controlling a user device in accordance with some examples of the disclosure;

FIG. 5 is a flowchart representing a process for controlling a user device in accordance with some examples of the disclosure;

FIG. 6 is a flowchart representing a process for controlling a user device in accordance with some examples of the disclosure;

FIG. 7 is a flowchart representing a process for controlling a user device in accordance with some examples of the disclosure;

FIG. 8 is a flowchart representing a process for controlling a user device in accordance with some examples of the disclosure;

FIG. 9 is a flowchart representing a process for controlling a user device in accordance with some examples of the disclosure;

FIG. 10 is a flowchart representing a process for controlling a user device in accordance with some examples of the disclosure;

FIG. 11 is a flowchart representing a further process for controlling a user device in accordance with some examples of the disclosure;

FIG. 12 shows an exemplary schematic representation of a location validation which may be used as part of controlling a user device in accordance with some examples of the disclosure;

FIG. 13 is a flowchart representing a further process for controlling a user device in accordance with some examples of the disclosure; and

FIG. 14 shows an exemplary schematic representation of a crowd-based identification validation which may be used as part of controlling a user device in accordance with some examples of the disclosure.

### DETAILED DESCRIPTION

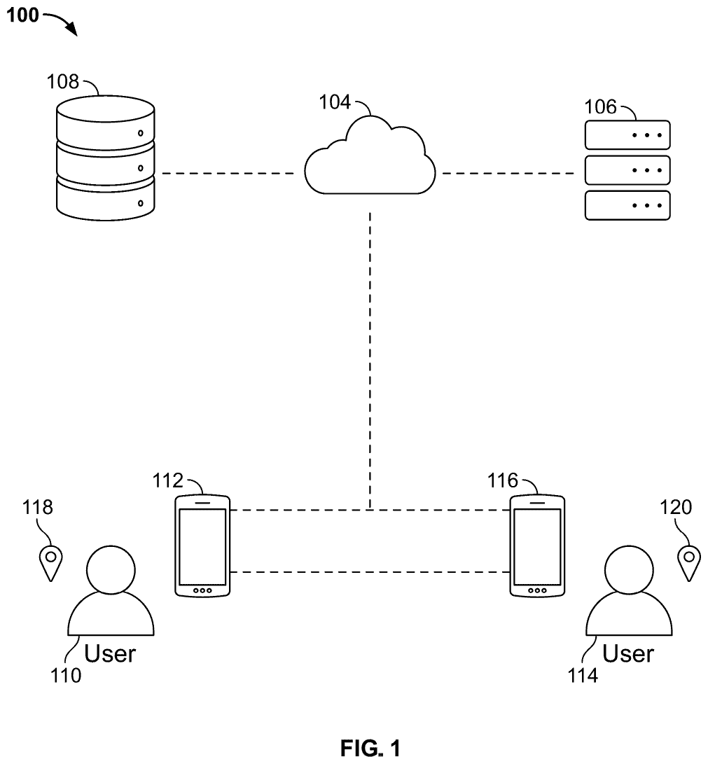

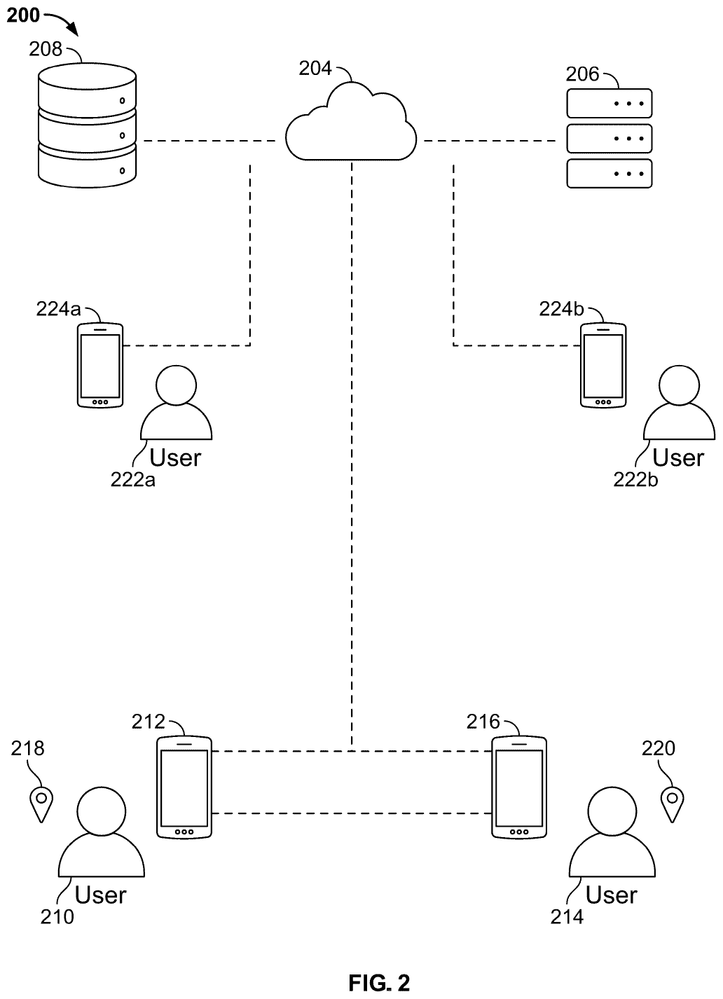

FIGS. 1 and 2 illustrate an overview of systems 100, 200, for controlling a user device (e.g., an extended reality (XR) device such as an XR headset), for example by obtaining data from a remote source, determining an interest of a first person relevant to a second person co-located with the first person, and generating a notification based on the determined interest, in accordance with some examples of the disclosure. In an embodiment, the systems 100, 200 determines that two people are co-located (e.g., within viewing distance of each other), detects a biometric response of a first person indicating a particular interest relevant to a second person co-located with the first person (e.g., by detecting a gaze of the first person directed at the second user), and causes a notification to be provided to the second user (e.g., notifying the second user of a potential “match” with a user in his or her vicinity).

Returning to FIGS. 1 and 2, in some examples, systems 100, 200, include a first user device 112, 212, which may be a mobile device, extended reality (XR) headset (e.g., AR glasses or a VR headset), a combination of a mobile device and an XR headset, or any suitable device. A first user 110, 210 may interact with the system 100, 200 via the first user device 112, 212. The systems 100, 200 may include a second user device 116, 216, which may be a mobile device, XR headset (e.g., AR glasses or a VR headset), a combination of a mobile device and an XR headset, or any suitable device. The second user 114, 214 may interact with the system 100, 200 via the second user device 116, 216. The first user 110, 210 may be present at a first location 118, 218 and the second user may be present at a second location 120, 220. In some examples the first location 118, 218 may be the same location as the second location 120, 220, or may be near the second location 120, 220 (e.g., near enough to be considered co-located). In some cases the first location 118, 218 may be different from the second location 120, 220.

The first user device 112, 212 and the second user device 116, 216 may, in some cases, be a tablet computer, a smartphone, a smart television, or the like, configured to display media content to one or more users. Systems 100, 200 may also each include network 104, 204 such as the Internet, configured to communicatively couple the first and second user devices 112, 116, 212, 216 to one or more servers 106, 206 and/or one or more content databases 108, 208 from which media content may be obtained for display on the user devices 112, 116, 212, 216. First and second user devices 112, 116, 212, 216 and server 106, 206 may be communicatively coupled to one another by way of network 104, 204 and server 106, 206 may be communicatively coupled to content database 108, 208 by way of one or more communication paths, such as a proprietary communication path and/or network 104, 204.

In the case of FIG. 2, other users 222a, 222b may be in a similar location to the first and second users 210, 214, or may be in a different location therefrom. The other users 222a, 222b may have other devices 224a, 224b associated therewith. Other devices 224a, 224b may be mobile devices, an XR headsets, a combination of mobile devices and an XR headsets or glasses, or any suitable devices. The other devices 224a, 224b may, in some cases, be tablet computers, a smartphones, smart televisions, or the like, configured to display media content to users.

Other devices 224a, 224b and server 106, 206 may be communicatively coupled to one another by way of network 104, 204 and the server 106, 206 may be communicatively coupled to content database 108, 208 by way of one or more communication paths, such as a proprietary communication path and/or network 104, 204.

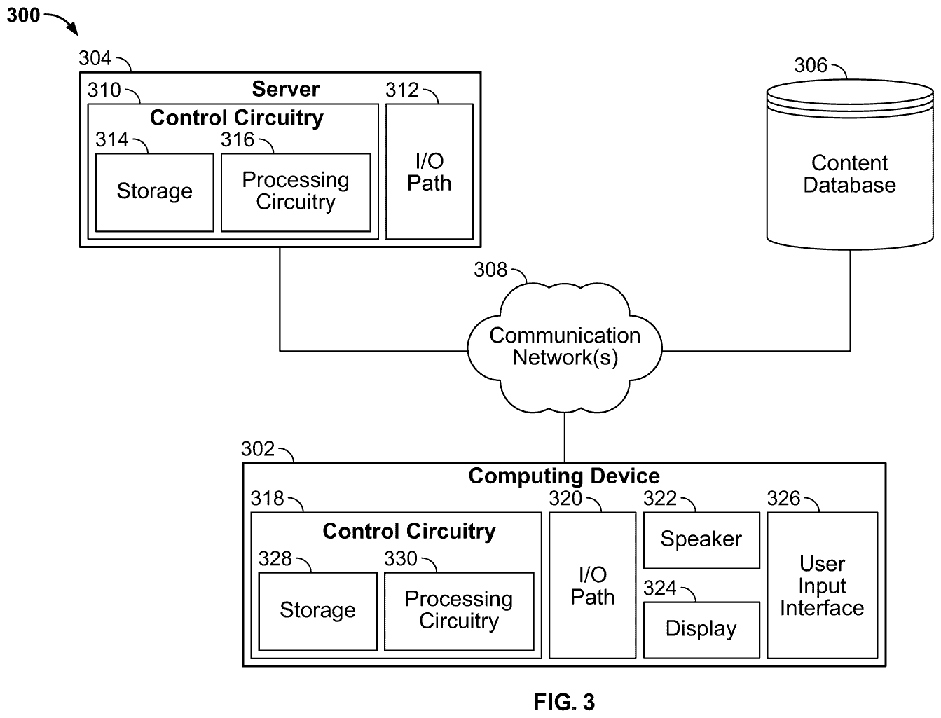

FIG. 3 is an illustrative block diagram showing an exemplary system 300 configured to determine a particular interest of a first user 110 (referred to as a computing device in FIG. 3), such as an interest in a second user 114 co-located or physically proximate to the first user 110, according to an embodiment. In an embodiment, the system 300 includes a first user device 302, which may be an XR headset (e.g., worn by a first user 110) that detects or determines a biometric response of the first user 110 or may be a computer/laptop/cellular phone to which an XR headset is connected. For example, the first user device 302 may detect a biometric response using biometric sensors physically in contact, or otherwise connected, to the first user 110. The biometric sensors may relay biometric data to the first user device 302, such as heart rate, direction of movement direction of gaze.

A user input interface 326 of the first user device 302 may be or include buttons or touch pads of an XR headset configured to receive input information from the first user 110. For example, the user may input information into the user input interface 326 confirming that are attracted to the second user 114, opening a message received from the second user 114, and/or granting permission to share personal information with the second user 114.

A display 324 of the first user device 302 may be or include a lens or screen of a XR headset configured to display information to the first user 110. The display 324 may display information indicated that a particular interest has been determined in relation to the first user 110 and/or the second user 114.

A speaker 322 of the first user device 302 may output audio information to the first user 110. For example, the speaker 322 may output a tone when a particular interest has been determined.

Although FIG. 3 shows system 300 as including a number and configuration of individual components, in some examples, any number of the components of system 300 may be combined and/or integrated as one device, e.g., as first user device 112 System 300 includes the first user device 302, server 304, and content database 306, each of which is communicatively coupled to communication network 308, which may be the Internet or any other suitable network or group of networks. In some examples, system 300 excludes server 304, and functionality that would otherwise be implemented by server 304 is instead implemented by other components of system 300, such as the first user device 302. In still other examples, server 304 works in conjunction with the first user device 302 to implement certain functionality described herein in a distributed or cooperative manner.

Server 304 includes control circuitry 310 and input/output (hereinafter “I/O”) path 312, and control circuitry 310 includes storage 314 and processing circuitry 316. Computing device 302, which may be a personal computer, a laptop computer, a tablet computer, a smartphone, a smart television, a smart speaker, or any other type of computing device, includes control circuitry 318, I/O path 320, speaker 322, display 324, and user input interface 326, which in some examples provides a user selectable option for enabling and disabling the display of modified subtitles. Control circuitry 318 includes storage 328 and processing circuitry 330. Control circuitry 310 and/or 318 may be based on any suitable processing circuitry such as processing circuitry 316 and/or 330. Processing circuitry 330 may determine a particular interest in accordance with embodiments discussed below.

As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 314, storage 328, and/or storages of other components of system 300 (e.g., storages of content database 306, and/or the like) may be an electronic storage device. The storage 328 may store profile information of the first user 110 and/or profile information of the second user 114 obtained from the server 304 or database 306. The storage 328 may further store historic biometric responses of the first user 110, predetermined thresholds for determining a particular interest, and predetermined thresholds for determining a predetermined distance between the first user 110 and the second user 114.

As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 314, storage 328, and/or storages of other components of system 300 may be used to store various types of content, metadata, and or other types of data. Non-volatile memory may also be used (e.g., to launch a boot-up routine and other instructions). Cloud-based storage may be used to supplement storages 314, 328 or instead of storages 314, 328. In some examples, control circuitry 310 and/or 318 executes instructions for an application stored in memory (e.g., storage 314 and/or 328). Specifically, control circuitry 314 and/or 328 may be instructed by the application to perform the functions discussed herein. In some implementations, any action performed by control circuitry 314 and/or 328 may be based on instructions received from the application. For example, the application may be implemented as software or a set of executable instructions that may be stored in storage 314 and/or 328 and executed by control circuitry 314 and/or 328. In some examples, the application may be a client/server application where only a client application resides on computing device 302, and a server application resides on server 304.

The application may be implemented using any suitable architecture. For example, it may be a stand-alone application wholly implemented on the first user device 302. In such an approach, instructions for the application are stored locally (e.g., in storage 328), and data for use by the application is downloaded on a periodic basis (e.g., from an out-of-band feed, from an Internet resource, or using another suitable approach). Control circuitry 318 may retrieve instructions for the application from storage 328 and process the instructions to perform the functionality described herein. Based on the processed instructions, control circuitry 318 may determine what action to perform when input is received from user input interface 326.

In client/server-based examples, control circuitry 318 may include communication circuitry suitable for communicating with an application server (e.g., server 304) or other networks or servers. Depending on the embodiment, the instructions for carrying out the functionality described herein may be stored, in whole or in part, on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 308). In another example of a client/server-based application, control circuitry 318 runs a web browser that interprets web pages provided by a remote server (e.g., server 304). For example, the remote server may store the instructions for the application in a storage device. The remote server may process the stored instructions using circuitry (e.g., control circuitry 310) and/or generate displays. The first user device 302 may receive the displays generated by the remote server and may display the content of the displays locally via display 324. This way, the processing of the instructions may be performed remotely (e.g., by server 304) while the resulting displays, such as the display windows described elsewhere herein, are provided locally on the first user device 302. The first user device 302 may receive inputs from the user via input interface 326 and transmit those inputs to the remote server for processing and generating the corresponding displays.

The first user 110 user may send instructions, e.g., to view a determined particular interest, to view a message received from the second user 114, to share personal information with the second user 114, and/or to upload/download profile data. The instructions may be sent to control circuitry 310 and/or 318 using user input interface 326. User input interface 326 may be integrated with or combined with display 324.

Server 304 and the first user device 302 may transmit and receive content and data via I/O path 312 and 320, respectively. For instance, I/O path 312 and/or I/O path 320 may include a communication port(s) configured to transmit and/or receive (for instance to and/or from content database 306), via communication network 308, content item identifiers, content metadata, natural language queries, and/or other data. Control circuitry 310, 318 may be used to send and receive commands, requests, and other suitable data using I/O paths 312, 320.

Returning to FIG. 1 and FIG. 2, a user 110, 210 may interact with systems and methods described herein for controlling a user device 112, 116, 212, 216, 224a, 224b.

In an example related to dating, a first user 110 quickly glances over at a second user 114 standing at the bar in a venue. The first user 110 finds the second user 114 quite attractive. The first user's XR headset inform them (or an associated user device 112) that the second user 114 is also interested in the first user 110. For example, the first person's user device 112 may determine that the second user 114 is interested in the first user 110 by accessing a server which provides relevant information stored on a database about the second user 114 (e.g., likes, dislikes, preferences, and biometric information). Upon determining that the second user 114 is interested in the first user 110, the first user device 112 may generate a user notification at the XR device of the first user 110 indicating that the second user 114 is interested in the first user 110 The XR headset and/or first user device 112 may also provide the possibility for the first user 110 to send the second user 114 a message, or add them to a list for a future contact or date. For example, upon receiving a user notification indicating the second user 114 is interested in the first user 110, the first user device 110 may generate an input request for displaying at the XR headset thereby providing the option to provide an input (e.g., a message or a request).

By combining biometric sensors, eye-tracking, location services and AR cameras with face identification intelligence and a social dating service, a new, automatic and immediate dating service can be created.

In the example shown in FIG. 1, a first user 110 may have an XR headset connected to the first user device 302 of FIG. 3. The XR headset and/or the first user device 302 may be connected to a plurality of sensors which measure the biometric values (i.e. biometric data) of the first user 110, such as pulse, breathing rate, temperature, movement, facial expressions and eye tracking as well as capturing additional information about their surrounding environment using a range of sensors including cameras and microphones. Information about each of their electromagnetic and radio surroundings as well as visible computer networking environments (such as communication network 308) can also be recorded, such as GPS/positioning signals, Bluetooth networks, 3G, 4G, 5G and wireless networks. Processing circuitry 316 may be used to perform combined and/or deeper analyses of these information streams in order to establish high degrees of certainty as to each user's physical location while they are connected with one or many augmented dating services. A second user 114 may also have an XR headset connected to the second user device 116. The XR headset and/or the second user device 116 may measure the biometric values of the second user 114, such as pulse, breathing rate, temperature, movement, facial expressions and eye tracking as well as capturing additional information about their surrounding environment using a range of sensors including cameras and microphones. Information about each of their electromagnetic and radio surroundings as well as visible computer networking environments (such as communication network 308) can also be recorded, such as global positioning system (GPS)/positioning signals, Bluetooth networks, 3G, 4G, 5G and wireless networks.

Even greater physical location certainty and physio-temporal resolution could be established on-demand through more active/real-time monitoring of the GPS location and surrounding wireless networks 308 (nearby service set identifier (SSIDs), Bluetooth networks, and the like) data of each user 110, 114. Cross-confirming one or more of each user's local information streams with those of other nearby users could be used to further increase the physio-temporal accuracy of information about any given user as necessary/required. Methods and techniques for location certainty are discussed later herein.

In some examples, when the first user 110 looks at the second user 114 and finds them attractive, the XR headset of the first user 110 may detect their prolonged glances, changing of body language (moving body, head movements, touching hair, etc), changes in pulse, breathing rate, facial expression (smiles) and possibly even pupil dilation. In examples where attraction is determined based on prolonged gaze, an uninterrupted gaze lasting for at least a predetermined gaze threshold (e.g. 30 seconds or one minute) may indicate attraction. In examples where attraction is determined based on a number of glances in the direction of the second user 114, a frequency of successive glances occurring within a predetermined duration may indicate attraction (e.g., 10 glances within five minutes). These indications of attraction are mapped forward into the surroundings of the first user 110 via position information from their forward facing cameras (direction) and eye tracking cameras (targeting).

By utilizing server-pushed location data of all nearby users logged on to the dating service, a locally-operated facial detection algorithm identifies the focus of the changes in the biometric activity of the first user 110 and verifies the face of the second user 114 as a verified and valid user of the dating app's services. At this point the dating service may not share any data between the users yet. The facial detection provides a few possible matches, but it is the potential dating service profile images, taken together with location information of the possible matches which confidently determines that the object of the interest of the first user 110 is, indeed the second user 114.

The second user 114 has already seen the first user 110, and the XR headset of the second user 114 have detected prolonged glances at the first user 110, together with smiles and an increased pulse. For example, prolonged glances of the second user 114 towards the first user 110 may be detected by the XR headset of the second user 114 using a motion sensors and/or a gyroscopic sensor to which the XR headset is connected. In some examples, a second user's 114 smile may be detected by camera connected to a XR headset of another user (e.g. the first user 110 or another user 222). Indication of a second user's 114 smile may be uploaded to the server 304/database 306 and the second user's XR headset may obtain the indication that the second user 114 is smiling from the server 304/database 306. In some examples, an increased pulse (increased heart rate) may be detected by a pulse monitor or heart rate monitor connected to a respective XR headset. A baseline heart rate or pulse may be predetermined by a developer or engineer (e.g., an average resting human heart rate) or set by the second user 114 (e.g., a threshold heart rate/pulse). An increased heart rate/pulse may be identified when the second user's 114 heart rate exceeds the predetermined baseline heart rate by a given percentage (e.g., 5%, 10% or 20%). The XR headset of the second user 114 has together with the dating service profile images detected the profile of the first user 110.

Depending on the dating service's settings, the users 110, 114 may receive a notification that someone seems interested in them, before they share the first level of their profile/username information with each other.

In one example implementation, both the first user 110 and the second user 114 are singles and have each agreed on sharing their online user names with people they are interested in. Accordingly, in this example both of their XR headsets inform them of the mutual interest and opportunity to choose whether to approach each other, to start with sending a message or two, or to save the contact for a contact another day (for example).

Increased precision in identity can be achieved by comparing sensor data between the pair of users 110, 114 that is being matched. Checking locally detectable radio interfaces available at the devices 112, 116 of each user 110, 114 may be verified against profiles on the server. For example, situational data related to aspects of a first and second user's 110, 114 environment may be uploaded to server 304 by respective XR headset. Each XR headset may then access the server 304 in order to obtain situational data uploaded by the other user and compare the uploaded situational data to situational data recently captured by their XR headset. When the situational data obtained from the server 304 matches recently captured situational data or a user's environment (e.g. the second user 114 uploaded a MAC address which matched the MAC address to which the first user 110 is presently connected), the identity of the second user 114 may be verified.

An AR-client-to-AR-client challenge/response procedure may also be added to increase security. That is, co-location of the first user 110 and the second user 114 may be further verified using public-key-infrastructure (PKI) challenge/response procedures and/or biometric challenge/response procedures, as discussed in more detail below. PKI challenge/response procedures may utilize wireless fidelity (WiFi) or Bluetooth networks, in which case a local presence is needed for both users. This may serve to prevent hacking attacks or impersonation attacks. Near field communication (NFC) may also be employed, but the working distance of NFC is relatively short when compared to, for example, Bluetooth or WiFi, so NFC may be preferred over very short distances.

In an example, if the second user 114 is not interested in the first user 110, nothing will get sent to either user 110, 114. The XR headset worn by the second user 114 may notice the interest and may check with the dating service, and if the interest is not returned by the first user 110, according to latest data, no notification may occur. If this changes, both the first user 110 and the second user may get notified.

In some cases, the AR glasses worn by the second user 114 and the second user's 114 online profile may remember the second user's 114 interest in the first user 110, and may also learn if the second user 114 tends to have preferences for certain physical looks (height, hair color, eye color etc.). This may be used to optimize matches automatically, if the second user 114 searches online for a date.

Crowd based identification may be achieved through collecting multiple users sensors data for a common location. Even if two persons are interested in each other, the AR cameras in their XR headsets might have difficulty in obtaining a good image. By crowd sourcing data from multiple XR headsets in the same location, a higher confidence can be obtained when determining a person's identity.

Each user's XR headset does not need to know who the user is, but a face geometry hash, or a photo may be sent to the server 106 for identification processing. Scanning the radio networks in the area can further strengthen the ID by comparing radio hardware addresses (MAC addresses and similar) with face geometry hash and location data from all users, both from the crowd as well as from the user 110, 114 which is being identified.

Identity verification protocols and location verification protocols may be performed both on-device locally as well as remotely via a cloud/server. For example, identity verification may be performed on the device 112 of the first user 110 and/or the device 116 of the second user 114 in order to identify/confirm the interest of each user 110, 114 in the other user 110, 114, which may be described as a unilateral confirmation of interest. Additionally or alternatively, network/server 104, 106 may be used to confirm the joint interest of both users 110, 114, which may be described as a bilateral confirmation of interest. Such verifications may be broadly divided into the following categories (1) to (6):

### (1) Facial Biometric Recognition Via XR Headset Sensors.

The XR headset of the first user 110 may notice, via local eye-tracking cameras, head-tracking accelerometers and attention monitoring biometrics that the first user 110 appears to be interested in a new user 114 within their field of view. Upon confirmation with the first user 110, their XR headset may send a hash of the user's 100 visible biometrics to the dating service 104, 106, 108 to request whether any potentially matching profiles are known to be in the physical location of the first user 110. If yes, the first user 110 is provided with the option of exploring more information about this person, the second user 114, making their interest known to the second user 114, tagging the second user's 110 profile for later consideration, or doing nothing.

### (2) Facial Biometric Recognition Via Challenge/Response Protocols Using XR Headset Sensors.

If the first user 110 makes their interest known to the second user 114, the second user 114 could be provided with the option of smiling and/or waving at the first user 110 within a brief time window. If the second user 114 is interested and smiles or waves at the first user 110 within the defined parameters, the suggested dating profile and the person interacting with the first user 110 are confirmed to be directly associated. If further identity verification is wanted or desired, additional one-off and ongoing verification strategies (server-based, XR headset based, third-party/′crowdsourced′) can be employed as needed.

### (3) User Profile Confirmation/Verification Via On-Demand Cloud/Server-Side Actions.

Verification of a user profile by virtue of information stored in a connected cloud/server may include auditory fingerprinting obtained via device microphones, and/or a time-stamped confirmation that each user's 110, 114 voice and/or audio environment is being experienced in real-time by the microphones on each user's XR headset, This security may be strengthened further by incorporating real-time confirmation of audio environment fingerprints from trusted security devices and/or multiple other users' 222a, 222b XR headsets within the same environment.

### (4) Wireless Networking Environment Fingerprinting Via Radio Network Interfaces.

In this scenario, time-stamped confirmation that changes to each user's 110, 114 wireless networking environment are being experienced by the networking radio interfaces of each user's 110, 114 XR headsets at the same time.

### (5) Physical Co-Location Confirmation/Verification Via Server-Side Monitoring of Each Profile's Local Environment and Behavior.

This includes the determination of physical location via GPS, wireless networking environments (e.g, via WiFi, Bluetooth, NFC), auditory environment fingerprinting/profiling via XR headset microphones, and hardware-level challenge/response protocols to 100% verify that each AR device uniquely represents the dating profile with which each user 110, 114 believes they are interacting.

In examples where location is determined (and verified) using WiFi, Bluetooth or NFC networks, the XR headset of the first user and the XR headset of the second user 114 may both be connected to the same network. A PKI challenge/response protocol may then be executed on the network to which both XR headsets are connected, as discussed in more detail below.

In an example, the first user's 110 XR headset requests for the server 106, 206 to send a PKI encrypted string to the second user's 114 dating profile. The second user's 114 XR headset may receive the string from their dating profile and may transmits it to the first user's 110 XR headset using a local connection (Bluetooth, WiFi, etc.), thus ensuring the 1-to-1 connection between the XR headset and dating profile, Additionally, the server 106, 306 may continue monitoring each of their profile accounts, thus ensuring the profiles are not used in any other locations or accessed by any other devices.

### (6) Physical Co-Location Confirmation/Verification Via Local XR Headset Interactions.

Hardware-level challenge/response protocols may be used to 100% verify that each XR headset uniquely represents the dating profile with which each user 110, 114 believes they are interacting. The first user's 110 XR headset may request for the server 106 to send a PKI-encrypted string to the second user's 114 dating profile. The second user's 114 XR headset may receive the string from their dating profile may transmit it to the first user's 110 XR headset using a local connection (Bluetooth, WiFi, etc.), thus ensuring the 1-to-1 connection between the XR headset and dating profile.

In some embodiments, XR headsets of other users 222 connected to the same network as the XR devices of the first and second users 110, 114 (Bluetooth, WiFi, etc.) may be used to further confirm the identity and/or location of the first user 110 and/or the second user 114. For example, the XR device of another user 222 may perform the above discussed PKI procedure with the XR device of the first user 110 and/or the XR device of the second user 114.

In certain embodiment, interest verification may also be performed by the XR headsets of the first user 110 and/or the second user 114.

Interest verification protocols may be performed both on-device locally, to identify/confirm the interest of each user 110, 114 in the other, described as unilateral confirmation of interest, as well as in the network/server 104, 106 to confirm the joint interest of both users 110, 114, described as bilateral confirmation of interest.

Interest may be verified using biometric data, using the following techniques: eye-tracking cameras, pupil dilation, excitement/arousal via heart-rate sensors, excitement/arousal via breathing rate analysis (e.g., via video/audio/biometric sensors), excitement/arousal via skin conduction analysis, excitement/arousal via movement pattern analysis (e.g., via video/microelectromechanical (MEMS) devices/biometric sensors).

Individual interest verification on-device by direct interrogation of each user (e.g. asking direct questions to the user) may be carried out. Joint interest verification via server confirmation of the interest status of each profile may also be carried out.

Server-side monitoring of each profile's local wireless networking, electromagnetic, auditory and visual environments in combination with biometric sensors with eye-tracking cameras mounted on XR headset, face recognition machine learning (ML), and location services may create automated systems and methods for users 110, 114 which are interested in each other. In particular, the server-side monitoring provides a means for user's to notice, express interest and connect with each other significantly more effectively and efficiently, while both users maintain their individual privacy and their abilities to appropriately manage the development and progression of their new relationship's earliest stages.

The above description provides examples of the disclosed embodiments in the context of identifying bidirectional and/or unidirectional attraction between two users in a dating context. However, it will be understood that the disclosed embodiments could be used to determine interest in multiple different contexts and situations. Some examples include, but are not limited to, sales and negotiations, gaining access to a venue with a digital pass, identifying common music/film interests, and identifying associates within the same organisation/society.

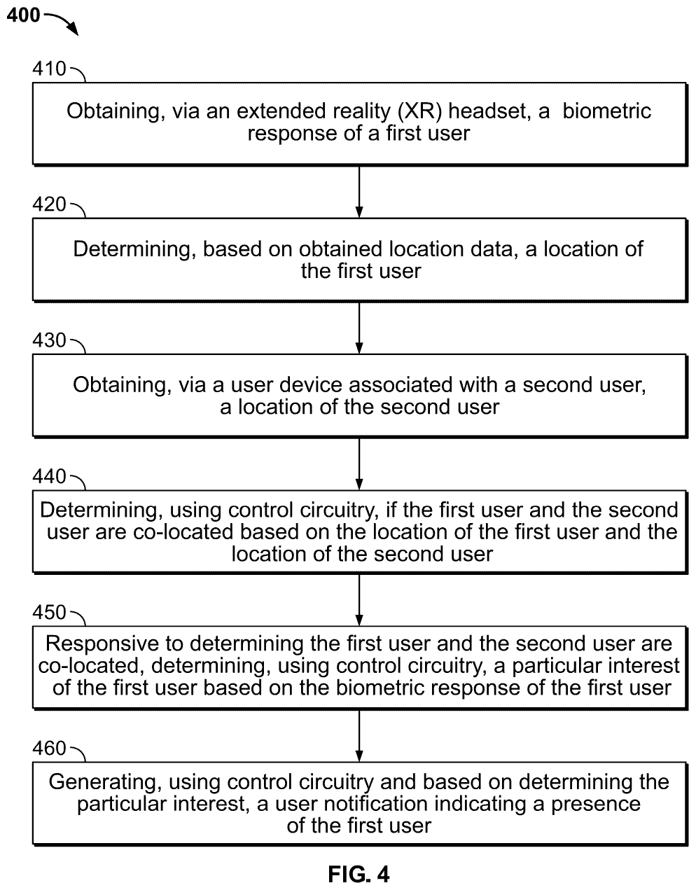

FIG. 4 shows a flowchart representing an illustrative process 400, according to an embodiment, for determining a particular interest of a first user 110 and for generating a notification, based on the determined interest, for a second user co-located with the first user. While the example shown in FIG. 4 refers to the use of system 100, as shown in FIG. 1, it will be appreciated that the illustrative process shown in FIG. 4 may be implemented, in whole or in part, on system 100 or system 200, either alone or in any combination, and/or on any other appropriately configured system architecture.

In the following description, processes 400 to 1000 will be describes from the perspective of the first user 110. However, it will be understood that the processes may be reversed and applied in the same way from the perspective of the second user 114, or any other user of a corresponding user device.

A user device may be any mobile user device having processing capacity and communication capabilities, such as a cellular mobile phone, an augmented reality device (e.g., augmented reality glasses), a mobile tablet or a laptop computer.

At step 410, a biometric response of a first user 110 is obtained via an XR headset. For example, the user device 112 may obtain the biometric response from the server 106 or the database 108 using the network 104. Additionally or alternatively, the user device 112 may generate the biometric response using processing circuitry of the user device connected to peripheral sensors, such as biometric sensors, and/or local data stored on the user device. For example, the biometric response may comprise biometric data acquired by biometric sensors attached to the first user 110 and in connection with the user device 112.

At step 420, a location of the first user 110 is determined based on obtained location data. For example, the location data of the first user 118 may be obtained from the server 106 or the database 108 using the network 104. Additionally or alternatively, the user device 112 may obtain the location data of the first user 118 locally using processing circuitry.

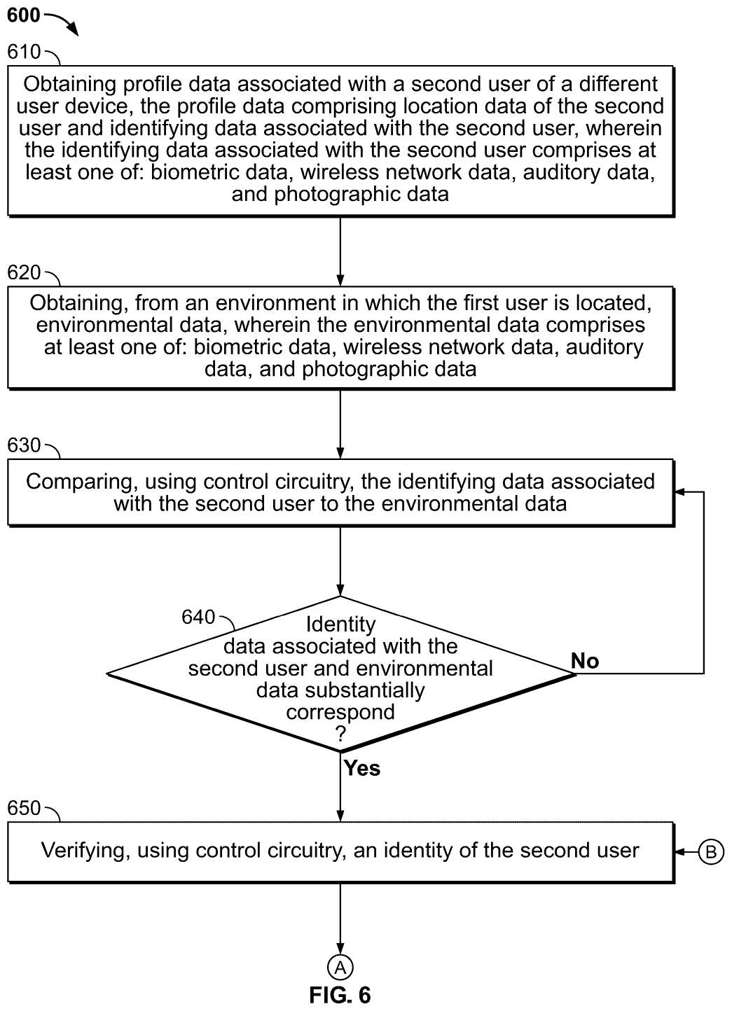

At step 430, a location of the second user 114 is obtained via a user device associated with a second user 114 (i.e. a different user device to the user device associated with the first user 110). The location of the second user 114 may be obtained via profile data associated with the second user, as discussed in more detail below with reference to FIG. 6.

At step 440, control circuitry determines if the first user 110 and the second user 114 are co-located based on the location of the first user 118 and the location of the second user 118. For example, the control circuitry may determine that the first and second users 110, 114 are co-located if the respective locations 118, 120 substantially correspond. Substantially correspond may be taken to mean that location data of the first user 118 and location data of the second user 118 are identical or are determined to both be within a predetermined distance of each other.

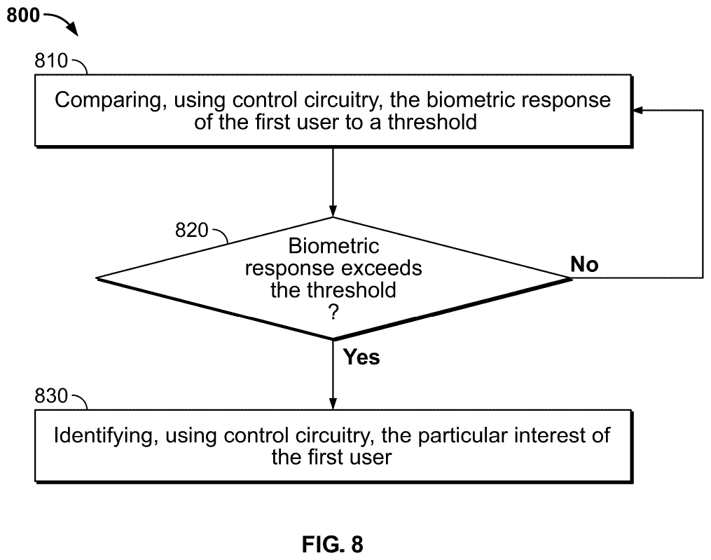

At step 450, responsive to determining the first user 110 and the second user 114 are co-located, control circuitry determines a particular interest of the first user 110 based on the biometric response. For example, the control circuitry may determine a particular interest based on a threshold, as discussed in more detail below with reference to FIG. 8. The control circuitry may only proceed to determine the particular interest of the first user 110 after first determining that the first user 110 and the second user 114 are co-located. Alternatively, the particular interest may be determined before the control circuitry determines whether or not the first user 110 and the second user 114 are co-located.

In some examples, the biometric response may be determined based on biometric data acquired by biometric sensors in connection with the user device 112. For example, a heart rate sensor fitted to the first user 110 may measure a heart rate of the first user 110 and transmit the measured heart rate to the user device 112. In response to receiving the heart rate data, the user device 112 may determine a biometric response of elevated heart rate, in response to which a particular interest may be determined. Examples of particular interests determined based on a biometric response of the first user 110 include, but are not limited to: a physical and/or emotional attraction to the second user (e.g, indicating a dating interest), an interest in a type of media content such as music being listened to and/or a film being watched, an interest in a product being marketed, and/or an interest in a conversation topic being discussed.

Other types of biometric sensors which may be used instead of or in addition to a heart rate sensor for obtaining a biometric response include: eye-tracking or gaze-tracking sensors (e.g., for monitoring the direction in which the first user 110 is looking and, for example, determining a length of time for which the first user 110 is looking at the second user 114), skin temperature sensors (e.g., for measuring changes in surface skin temperature in order to sense elevated skin temperature and therefore identify possible excitement of the first user 110), facial expression sensors (e.g., for monitoring facial expressions of the first user 110 in order to determine an emotional reaction to a person and/or situation), breathing rate sensors (e.g., for measuring a breath rate of the first user 110 and therefore identify possible excitement of the first user 110), skin conduction sensors, accelerometers and gyroscopes (e.g., for measuring movement of the first user 110 and determining an emotional state based on erratic and/or excessive movement), and pupil dilation sensors (e.g., for measuring changes in pupil dilation of the first user to identify excitement and/or a change in emotion of the first user 110).

In some examples where the particular interest is both an interest of the first user 110 and an interest of the second user 114 (e.g., a corresponding interest or a “shared interest”), the (corresponding) particular interest may be determined if the biometric response of the first user 110 (e.g., biometric data) and profile data of the second user (e.g., biometric data) 114 both exceed a threshold (e.g., for heart rate, the threshold may be the average resting human heart rate such as 75 beats per minute; for glance duration, the threshold may be a frequency of glances within a predetermined time such as ten glances within five minutes). The (corresponding) particular interest may include, but is not limited to, e.g., a mutual physical attraction, a mutual task to be completed (e.g., gaining access to a venue or purchase-sale of a product), a common music interest, a common film interest, mutual consent to meet and/or exchange sensitive information, and mutual interest in an organization and/or society.

At step 460, based on determining the particular interest, control circuitry generates a user notification indicating a presence of the first user 110. For example, the user notification may indicate the first user 110 is present at the same location as the second user 114 (e.g., the first and second users 110, 114 are co-located). The user notification may additionally indicate that the first user 110 has a particular interest that is relevant to the second user 114 (e.g., the first user 110 is attracted to the second user 114). In examples where the particular interest is both an interest of the first user 110 and an interest of the second user 114 (e.g., a corresponding interest), the user notification may additionally indicate the corresponding interest between the two users.

The user notification may be sent to the different user device 116 of the second user 114. For example, the user notification may be transmitted directly to the different user device 116 using a wireless networks, such as WiFi, 4G, 5G, or Bluetooth.

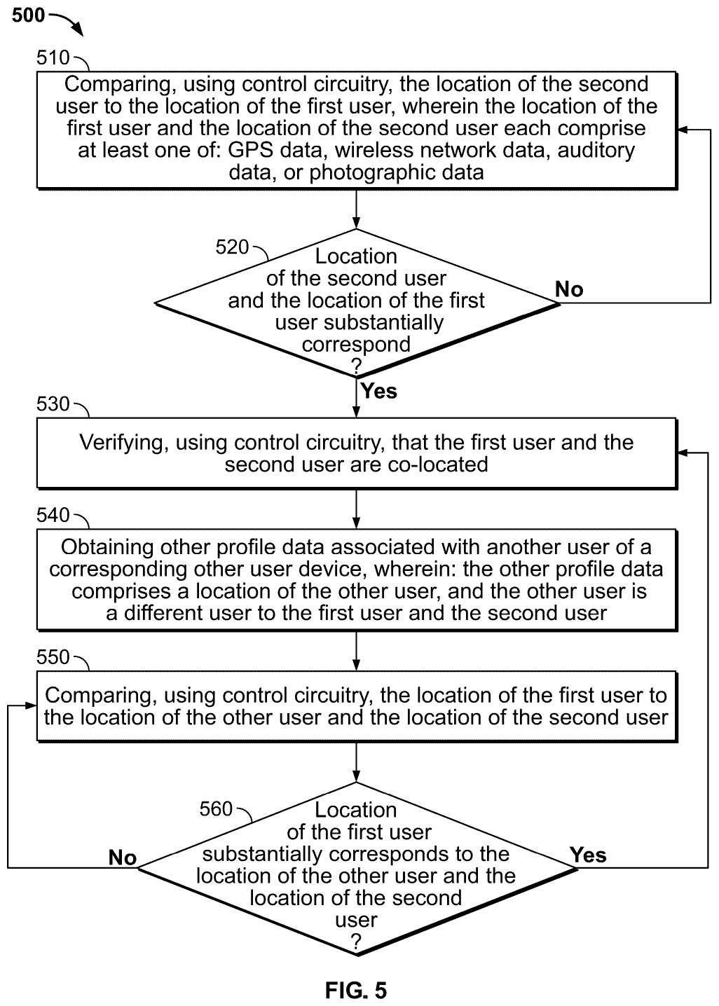

The actions or descriptions of FIG. 4 may be used with any other example of this disclosure, e.g., the example described below in relation to FIGS. 5-10. In addition, the actions and descriptions described in relation to FIG. 4 may be done in any suitable alternative orders or in parallel to further the purposes of this disclosure. For example, in some embodiments, the particular interest is determined prior to determining co-location. In some embodiments, co-location is determined prior to determining the particular interest.

FIG. 5 shows a flowchart representing an illustrative process 500 for verifying that a first user 110 and a second user 114 are co-located, according to an embodiment. In an embodiment, implementing the step 440 of the process 400 involves implementing the process 500, in whole or in part. In some instances, implementing the step 440 may involve implementing alternative or additional steps to those included in process 500. In any event, while the example process 500 shown in FIG. 5 refers to the use of system 100, as shown in FIG. 1, it will be appreciated that the illustrative process shown in FIG. 5 may be implemented, in whole or in part, on system 100 or system 200, either alone or in any combination, and/or on any other appropriately configured system architecture.

In the illustrative process 500 shown in FIG. 5, the location of the first user 118 and the location of the second user 120 each comprise GPS data (which may include geographical location coordinates representing points of intersection in a grid system), wireless network data, auditory data and/or photographic data.

The wireless network data may comprise identifiers of one or more wireless networks to which the first user 110 is connected. Examples of such wireless networks include, e.g., WiFi, radio access networks (e.g., 4G/5G), Bluetooth, NFC. An identifier of a wireless network may comprise a radio hardware address.

The wireless network data may be associated with a specific geographical location. For example, wireless network data may be wireless network data of a wireless network provided by a library or coffee shop. Therefore, location data which comprises wireless network data may be used to identify a location of the first user 110 by determining that the first user 110 is connected to a wireless network associated with a certain geographical location (e.g. the geographical location of the library or coffee shop).

The auditory data may be acquired by a microphone of the corresponding user device. For example, the microphone may capture audio from the surrounding environment in which the corresponding user is located (e.g., music being played from a radio and/or nearby conversations).

The photographic data may be acquired by a camera of the corresponding user device. For example, the camera may capture a photo including images from the surrounding environment in which the corresponding user is located (e.g., nearby landmarks and/or road signs).

At step 510, control circuitry compares the location of the second user 120 to the location of the first user 118. For example, where the location of the second user 120 and the location of the first user 118 both comprise GPS data, the coordinates of the respective GPS data are compared. Where the location of the second user 120 and the location of the first user 118 both comprise wireless network data, the radio hardware addresses of the respective wireless network data are compared. Where the location of the second user 120 and the location of the first user 118 both comprise auditory data, audio signals (e.g., frequency spectrums) of the respective auditory data are compared. Where the location of the second user 120 and the location of the first user 118 both comprise photographic data, the images from of the respective photographic data are compared. The images from the respective photographic data may be compared using digital image processing techniques. It will be understood that the locations may comprise two of more of the following data types: GPS data, wireless network data, auditory data and/or photographic data, in which case each pair of matching data type is compared in step 510 and processed in the following steps of process 500.

At step 520, control circuitry determines whether or not the location of the second user 120 and the location of the first user 118 substantially correspond based on the comparison performed in step 510. If the location of the second user 120 and the location of the first user 118 do substantially correspond, the process 500 proceeds to step 530 where control circuitry verifies that the first user 110 and the second user 114 are co-located.

Verification that the first user 110 and second user 114 are co-located may be included in the user notification generated in step 460. Once the first user 110 and/or the second user 114 are made aware that they are co-located (e.g., by receiving and/or viewing the user notification which indicates co-location), the first user 110 and/or the second user 114 may give consent to exchange further information about each other, such as names, phone numbers, addresses, profile pictures. Therefore, until consent is provided by both parties, the personal data of the first user 110 and the second user 114 remains secure and private to the respective user.

Substantially corresponding location data may be taken to be items of location data that both meet a minimum threshold of correspondence. For example, where the location of the second user 120 and the location of the first user 118 both comprise GPS data, the minimum threshold of correspondence may be met if a certain proportion of the GPS data coordinates match. In an embodiment, the minimum threshold of correspondence may be data indicating an absolute physical distance. For example, in an embodiment, the two people must be within a certain distance of each other (e.g., 5 feet, 20 feet, 50 feet, 1 mile). In an embodiment, the minimum threshold of correspondence may be data indicating match percentage. Where the location data includes GPS data coordinates, the minimum threshold of correspondence may be an overlap in matching coordinates that exceeds 60%, 75%, 90% or 100%. For example, GPS coordinates of the first user 110 may be 48.858 latitude and 2.355 longitude, whereas the GPS coordinates of the second user 114 may be 48.853 latitude and 2.359 longitude, in which case the overlap in matching coordinates would be 78%. In an embodiment, the minimum threshold of correspondence may be data indicating a threshold value for signal strength (e.g., indicating a percentage, an RSSI value, a dBm value, etc.). A threshold value for signal strength may be used in embodiments where wireless PAN or LAN signals transmitted by the user devices are analyzed to inform proximity of the devices to each other or to known locations of known devices (e.g., wherein each of the user devices is sufficiently proximate to the same known device to conclude they are co-located). Stronger signal strength generally indicates closer proximity, and the threshold value may be selected accordingly. Where the location data of the second user 120 and the location data of the first user 118 both comprise wireless network data, the minimum threshold of correspondence may be met if a certain proportion of the radio hardware addresses match (e.g., 60%, 75%, 90% or 100% matching digits of the hardware addressees). For example, the MAC address associated with a network of the first user 110 may be 2C:54:91:88:C9:E3 and the MAC address associated with a network of the second user 114 may be 2:54:91:88:C9:D2, in which case the overlap in radio hardware addresses would be 83%. In some instances, sound detected by the user devices may be utilized to inform whether or not the two user devices are co-located (e.g., same or similar ambient sounds may suggest the two devices are co-located). For example, where the location of the second user 120 and the location of the first user 118 both comprise auditory data, the minimum threshold of correspondence may be met if a certain proportion of the audio signal match (e.g., 60%, 75%, 90% or 100% matching frequencies). In some instances, the user devices may capture images or video. For example, a person might use his smart phone to capture an image. As another example, a person may wear an XR headset that captures an image of the person's field of view (e.g., regularly, semi-regularly, or one-shot), which may occur automatically or manually. Where the location of the second user 120 and the location of the first user 118 both include image data, the minimum threshold of correspondence may be met if a certain proportion of the images match (e.g., 60%, 75%, 90% or 100% matching images).

If the location of the second user 120 and the location of the first user 118 do not substantially correspond, the process 500 moves back to step 510.

At step 540, other profile data associated with another user 224 of a corresponding other user device 222 is obtained. The other user 222 is a different user to the first user 110 and the second user 114. For example, the other profile data of the other user 222 may be obtained from a user profile of the other user 222 stored on the server 106 and/or the database 108 via the network 104. The other profile data associated with the other user 22 may alternatively be obtained directly from the other user device 224 being operated by the other user 224 (e.g., using Bluetooth). The other profile data comprises location data of the other user 222. The other profile data associated with the other user 222 may comprise at least the same type of data as user data associated with the first user 110 and/or profile data associated with the second user 114.

The other user may be any other user (apart from the first user 110 and the second user 114) of a corresponding user device having the same functional capabilities as user devices 112 and 116.

At step 550, control circuitry compares the location of the other user to the location of the first user 118 and the location of the second user 120 to determine whether the location of the other user substantially corresponds to the location of the first user 118 and the location of the second user 120 and that the other user is co-located with the first and second users 110, 114. For example, where the location of the other user, the location of the second user 120 and the location of the first user 118 all comprise GPS data, the coordinates of the respective GPS data are compared. Where the location of the other user, the location of the second user 120 and the location of the first user 118 all comprise wireless network data, the radio hardware addresses of the respective wireless network data are compared. Where the location of the other user, the location of the second user 120 and the location of the first user 118 all comprise auditory data, audio signals (e.g., frequency spectrums) of the respective auditory data are compared. Where the location of the other user, the location of the second user 120 and the location of the first user 118 all comprise photographic data, the images from of the respective photographic data are compared. It will be understood that the location may comprise two of more of the following data types: GPS data, wireless network data, auditory data and/or photographic data, in which case each set of three matching data types is compared in step 550 and processed in the following steps of process 500.

At step 560, control circuitry determines whether or not the location of the other user, the location of the second user 120 and the location of the first user 118 all substantially correspond based on the comparison performed in step 550. If the location of the other user, the location of the second user 120 and the location of the first user 118 do all substantially correspond, the process 500 proceeds to step 530 where control circuitry verifies that the other user 222, the first user 110 and the second user 114 are all co-located.

Verification that the other user 222, the first user 110 and second user 114 are co-located may be included in the user notification generated in step 460. Verification that all three users are co-located may be used to confirm the previously determined verification in step 530 that the first user 110 and the second user 114 are co-located.

If the location data of the second user 120 and the location data of the first user 118 do not substantially correspond, the process 500 moves back to step 550.

The actions or descriptions of FIG. 5 may be used with any other example of this disclosure. In addition, the actions and descriptions described in relation to FIG. 5 may be done in any suitable alternative orders or in parallel to further the purposes of this disclosure.

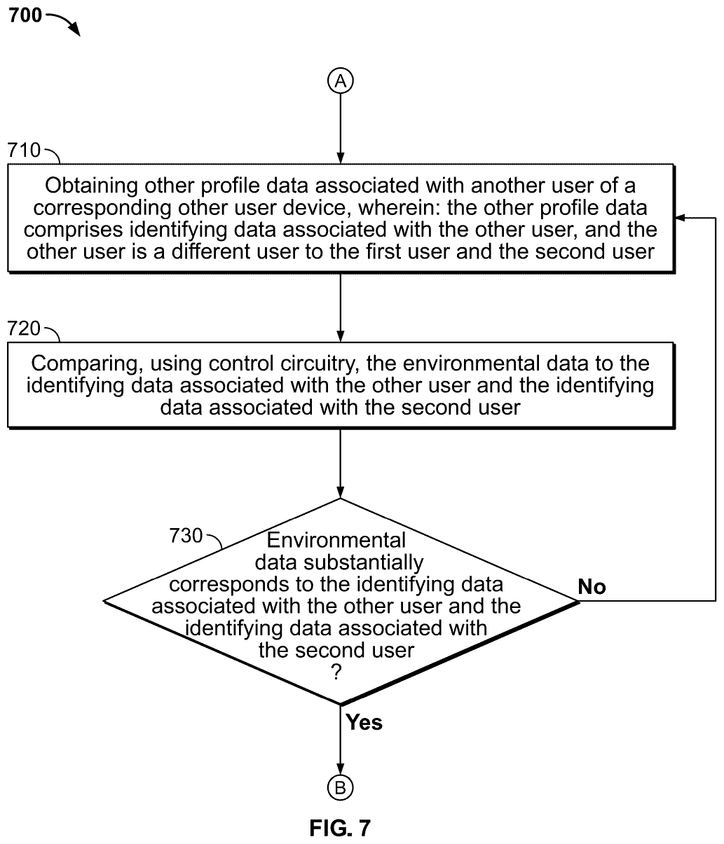

FIG. 6 and FIG. 7 show flowcharts representing an illustrative process 600 for determining a particular interest of a first user 110, according to an embodiment. In an embodiment, implementing the step 450 involves implementing, in whole or in part, the process 600. In some instances, implementing the step 450 may involve implementing alternative or additional steps to those included in process 600. In any event, while the example shown in FIG. 6 refers to the use of system 100, as shown in FIG. 1, it will be appreciated that the illustrative process 600 may be implemented, in whole or in part, on system 100 or system 200, either alone or in any combination, and/or on any other appropriately configured system architecture.

At step 610, profile data associated with the second user 114 of the different user device 114 is obtained. For example, the profile data may be obtained from a user profile of the second user 114 stored on the server 106 and/or the database 108 via the network 104. The profile data associated with the second user 114 may alternatively be obtained directly from the different user device 116 being operated by the second user 114 (for example, via Bluetooth). The profile data associate with the second user 114 comprises location data 120 of the second user 114. The profile data associated with the second user 114 may comprise at least the same data as the user data associated with the first user 110. In process 600, the profile data comprises location data of the second user 114 and identification data associated with the second user 114. The identification data associated with the second user 114 comprises at least one of: biometric data, wireless network data, auditory data, and photographic data. The biometric data may be acquired by biometric sensors attached to the second user 114 and in connection with the different user device 114. The wireless network data may comprise a radio hardware address (such as a MAC address) indicating a wireless network to which the different user device 116 of the second user 114 is connected. The auditory data may comprise audio recorded by a microphone of the different user device 116. The photographic data may comprise images captured by a camera of the different user device 116.

At step 620, situational data is obtained from an environment in which the first user is located. In an embodiment, example situational data comprises: biometric data, wireless network data, auditory data, image data, etc. The biometric data may be acquired by biometric sensors attached to the first user 110 and in connection with the user device 112. The wireless network data may comprise a radio hardware address (such as a MAC address) indicating a wireless network to which the user device 112 of the first user 110 is connected. The auditory data may comprise audio recorded by a microphone of the user device 112. The photographic data may comprise images captured by a camera of the user device 112.

Situational data may be taken to be any data that provides information about the environmental situation in which the first user 110 is located. For example, the biometric data of the situational data may indicate a direction in which the first user 110 in looking and/or a direction in which the first user 110 is moving within the environment. The biometric data may also indicate visible biometric data, such as hand waving, hand signals and facial expressions The wireless network data of the situational data may indicate a wireless network to which the user device 112 is connected within the environment. The auditory data of the situational data may indicate audio recorded of the environment. The photographic data of the situational data may indicate a landmark or sign in the environment.

At step 630, control circuitry compares the identification data associated with the second user to the situational data. For example, where the identification data of the second user 120 and the situational data of the first user 118 both comprise biometric data, such as hand signals, the hand signals of the respective biometric data are compared. For example, the biometric data may be used to execute biometric call and response procedures, such as one user waving back to another user. Where the identification data of the second user 120 and the situational data of the first user 118 both comprise wireless network data, the radio hardware addresses of the respective wireless network data are compared. Where the identification data of the second user 120 and the situational data of the first user 118 both comprise auditory data, audio signals (e.g., frequency spectrums) of the respective auditory data are compared. Where the identification data of the second user 120 and the situational data of the first user 118 both comprise photographic data, the images from of the respective photographic data are compared. The images from the respective photographic data may be compared using digital image processing techniques. It will be understood that the identification data and the situational data may comprise two of more of the following data types: biometric data, wireless network data, auditory data and/or photographic data, in which case each pair of matching data type is compared in step 630 and processed in the following steps of process 600.

At step 640, control circuitry determines whether or not the identification data of the second user 114 and the situational data of the first user 110 substantially correspond based on the comparison performed in step 630. If the identification data of the second user 114 and the environmental data of the first user 110 do substantially correspond, the process 600 proceeds to step 650 where control circuitry verifies the identity of the second user 114.

Verifying the identity of the second user 114 may be taken to mean verifying that the second user 114 is the rightful owner of the different user device 116 and/or verifying that the second user 114 is the person in a user profile associated with the different user device 116.

Verification of the second user's 114 identity may be included in the user notification generated in step 460. Once the first user 110 is made aware that the second user's identity has been verified (e.g., by receiving and/or viewing the user notification which indicates verification), the first user 110 and/or the second user 114 may give consent to exchange further information about each other, such as names, phone numbers, addresses, profile pictures. Therefore, until consent is provided by both parties, the personal data of the first user 110 and the second user 114 remains secure and private to the respective user.

Substantially corresponding identification data and situational data may be taken to mean that both types of data meet a minimum threshold of correspondence. For example, where the identification data and situational data both comprise (visible) biometric data, the minimum threshold of correspondence may be met if a call and response procedure is completed (e.g., waving to each other) and/or where facial recognition confirms that a certain percentage of the second user's face captured by a camera of the user device 112 corresponds to a photo of the second user's face stored in a user profile (obtained as part of the identification data in step 610). Where the identification data and situational data both comprise wireless network data, the minimum threshold of correspondence may be met if a certain proportion of the radio hardware addresses match (e.g., 60%, 75%, 90% or 100% matching digits of hardware addressees). Where the identification data and situational data both comprise auditory data, the minimum threshold of correspondence may be met if a certain proportion of the audio signal match (e.g., 60%, 75%, 90% or 100% matching frequencies). Where the location data of the second user 120 and the location data of the first user 118 both comprise photographic data, the minimum threshold of correspondence may be met if a certain proportion of the images match (e.g., 60%, 75%, 90% or 100% matching images).

If the identification data and situational data do not substantially correspond, the process 600 moves back to step 630.

At step 710, other profile data associated with another user of a corresponding other user device 224 is obtained, as discussed above in relation to process 500. In process 600, the other profile data also comprises identification data associated with the other user 222. The other user 222 is a different user to the first user 110 and the second user 114. The other profile data associated with the other user 222 may comprise at least the same type of data as the user data associated with the first user 110 and/or the profile data associated with the second user 114.

The other user 222 may be any other user (apart from the first user 110 and the second user 114) of a corresponding user device having the same functional capabilities as user devices 112 and 116.

At step 720, control circuitry compares the situational data (associated with the first user 110) to the identification data associated with the other user 222 and the identification data associated with the second user 114 (i.e. to determine whether the identification data of the other user 222 substantially corresponds to the situational data of the first user 110 and the identification data of the second user 114). For example, where the data all comprises (visible) biometric data, the (visible) biometric data is compared to determine whether a biometric call and response procedure has been completed and/or whether facial recognition has been completed. Where the data all comprises wireless network data, the radio hardware addresses of the respective wireless network data are compared. Where the data all comprises auditory data, audio signals (e.g., frequency spectrums) of the respective auditory data are compared. Where the data all comprises photographic data, the images from of the respective photographic data are compared. It will be understood that the identifications data and the situational data may each comprise two of more of the following data types: biometric data, wireless network data, auditory data and/or photographic data, in which case each set of three matching data types is compared in step 720 and processed in the following steps of process 600.

At step 730, control circuitry determines whether or not the situational data (associated with the first user 110), the identification data associated with the other user 222 and the identification data associated with the second user 114 all substantially correspond based on the comparison performed in step 720. If the situational data, the identification data associated with the other user 222 and the identification data associated with the second user 114 do all substantially correspond, the process 600 proceeds to step 650 where control circuitry verifies the identity of the second user 114.

Verification of the identity of the second user 114 based on identification data associated with the other user 222, in addition to situational data associated with the first user 110 and identification data associated with the second user 114, may be included in the user notification generated in step 460 and may be used to confirm the previous determined verification in step 650.

If the situational data, the identification data associated with the other user 222 and the identification data associated with the second user 114 do not all substantially correspond, the process 600 moves back to step 710.

The actions or descriptions of FIG. 6 and FIG. 7 may be used with any other example of this disclosure. In addition, the actions and descriptions described in relation to FIG. 6 and FIG. 7 may be done in any suitable alternative orders or in parallel to further the purposes of this disclosure.

FIG. 8 shows a flowchart representing an illustrative process 800 for determining whether the biometric response exceeds a threshold, in which a biometric response is compared to a threshold in order to identify whether or not a particular interest exists, according to an embodiment. In an embodiment, implementing the step 450 of the process 400 involves implementing the process 800, in whole or in part. In some instances, implementing the step 450 may involve implementing alternative or additional steps to those included in process 800. In any event, while the example process 800 shown in FIG. 8 refers to the use of system 100, as shown in FIG. 1, it will be appreciated that the illustrative process 800 shown in FIG. 8 may be implemented, in whole or in part, on system 100 or system 200, either alone or in any combination, and/or on any other appropriately configured system architecture.

At step 810, control circuitry compares the biometric response of the first user 110 to a threshold (e.g., in order to determine whether the biometric response should be categorized as a particular interest of the first user 110). For example, the threshold may be a predetermined threshold set by a developer or engineer. Alternatively, the threshold may be a predetermined threshold set by the first user 110.

In examples where the threshold is a predetermined threshold set by a developer or engineer, the predetermined threshold may be set based on an average of the associated biometric response. For example, where the biometric response is based on a measured heart rate of the first user 110, the predetermined threshold may be set as the average resting heart rate of a human.

In order to perform the comparison of biometric response to the threshold, the biometric response may be converted to an integer number and/or a character string which can be compared to the threshold. For example, a biometric response indicating a first user heart rate may be converted into a heart rate of 115 beats per minute and compared to a predetermined threshold of 75 beats per minute.

In examples where the threshold is a predetermined threshold set by the first user 110, the predetermined threshold can be adjusted in accordance with user requirements. The predetermined threshold may be considered as met if the biometric response is determined to be greater than or equal to the predetermined threshold.

At step 820, control circuitry determines whether the biometric response meets the threshold. In some embodiments, the control circuitry may determine whether the biometric response is equal to or greater than the threshold. For example, if a first user heart beat of 115 beats per minute is obtained with the biometric response, the control circuitry determined that a threshold of 75 beats per minute has been met, because 115 beats per minute is greater than 75 beats per minute. If the threshold is determined to have been met, the process 800 proceeds to step 830 where the particular interest of the first user 110 is identified.

If the threshold is determined to have not been met, the process 800 moves back to step 810.

The actions or descriptions of FIG. 8 may be used with any other example of this disclosure. In addition, the actions and descriptions described in relation to FIG. 8 may be done in any suitable alternative orders or in parallel to further the purposes of this disclosure.

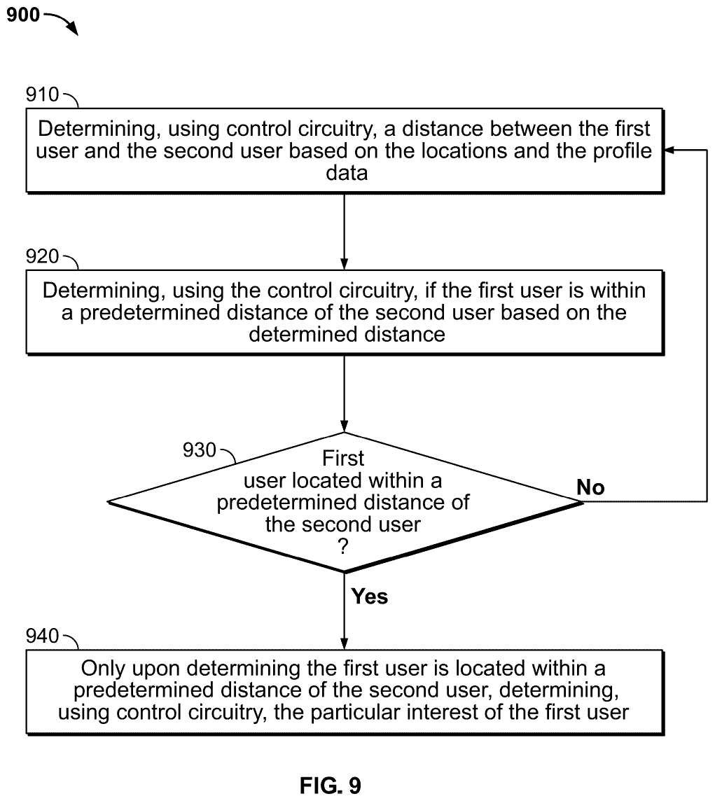

FIG. 9 shows a flowchart representing an illustrative process 900 for determining co-location, in which co-location between the first user 110 and the second user 114 is determined based on a predetermined distance, according to an embodiment. In an embodiment, implementing the step 440 of the process 400 involves implementing the process 900, in whole or in part. In some instances, implementing the step 440 may involve implementing alternative or additional steps to those included in process 900. In any event, while the example shown in FIG. 9 refers to the use of system 100, as shown in FIG. 1, it will be appreciated that the illustrative process 900 shown in FIG. 9 may be implemented, in whole or in part, on system 100 or system 200, either alone or in any combination, and/or on any other appropriately configured system architecture.

At step 910, control circuitry determines a distance between the first user 110 and the second user 114 based on the location of the first user 118 and the location of the second user 120 (which are obtained as described in relation to process 400, above).

The distance between the first user 110 and the second user 114 may be determined by converting the respective locations to geographical coordinates and determining the distance between the respective sets of geographical coordinates (in centimeters, meters or kilometers).

At step 920, control circuitry determines if the first user 110 is within a predetermined distance of the second user 114 based on the determined distance. For example, the determined distance (in centimeters, meters or kilometers) is compared to the predetermined distance (in centimeters, meters or kilometers) to determine whether the determined distance is equal to or less than the predetermined distance.

At step 930, if the first user 110 is determined to be within the predetermined distance of the second user 114, the process 900 proceeds to step 940. For example, if the determined distance between the users is 1.5 meters and the predetermined distance is 2 meters, the first user 110 is determined to be within the predetermined distance. If the first user 110 is not determined to be within the predetermined distance (i.e. is further away from the second user 114 than the predetermined distance), the process 900 returns to step 910.

At step 940, control circuitry determines the particular interest of the first user 110 only if it has previously been determined that the first user 110 is located within a predetermined distance from the second user 114. That is, in the process 900, control circuitry will only proceed to determine the particular interest if it has first been determined that the first and second users 110, 114 are co-located (i.e. within a predetermined distance from each other).

The actions or descriptions of FIG. 9 may be used with any other example of this disclosure. In addition, the actions and descriptions described in relation to FIG. 9 may be done in any suitable alternative orders or in parallel to further the purposes of this disclosure.

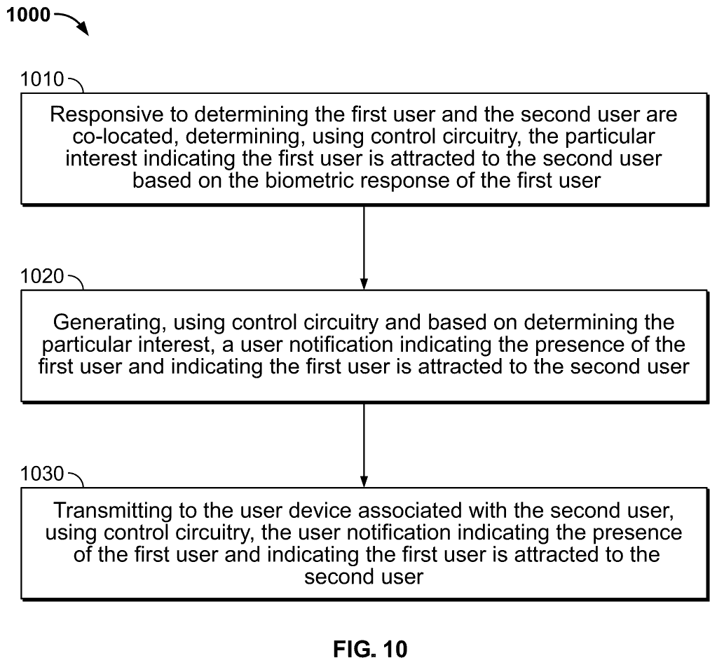

FIG. 10 shows a flowchart representing an illustrative process 1000 for determining a particular interest of a first user 110, in which the user notification indicates the presence of the first user 110 and indicates the first user 110 is attracted to the second user 114. In an embodiment, implementing the step 460 of the process 400 involves implementing the process 1000, in whole or in part. In some instances, implementing the step 460 may involve implementing alternative or additional steps to those included in process 1000. In any event While the example shown in FIG. 10 refers to the use of system 100, as shown in FIG. 1, it will be appreciated that the illustrative process 1000 shown in FIG. 10 may be implemented, in whole or in part, on system 100 or system 200, either alone or in any combination, and/or on any other appropriately configured system architecture.

At step 1010, control circuitry determines that the particular interest of the first user 110 indicates the first user 110 is attracted to the second user 114 based on the biometric response of the first user 110. Determining the particular interest may be performed as described above in relation to process 400.

At step 1020, control circuitry generates the user notification indicating the presence of the first user 110 and indicating the first user is attracted to the second user, based on the particular interest determined in step 1010. The user notification may be generated as described above in relation to process 400.

At step 1030, control circuitry transmits the user notification indicating the presence of the first user 110 and indicating the first user 110 is attracted to the second user 114 to the user device 116 associated with the second user 114. For example, the user notification may be transmitted using transmitter circuitry of the user device 112 via a wireless and/or cellular network.

The actions or descriptions of FIG. 10 may be used with any other example of this disclosure. In addition, the actions and descriptions described in relation to FIG. 10 may be done in any suitable alternative orders or in parallel to further the purposes of this disclosure.

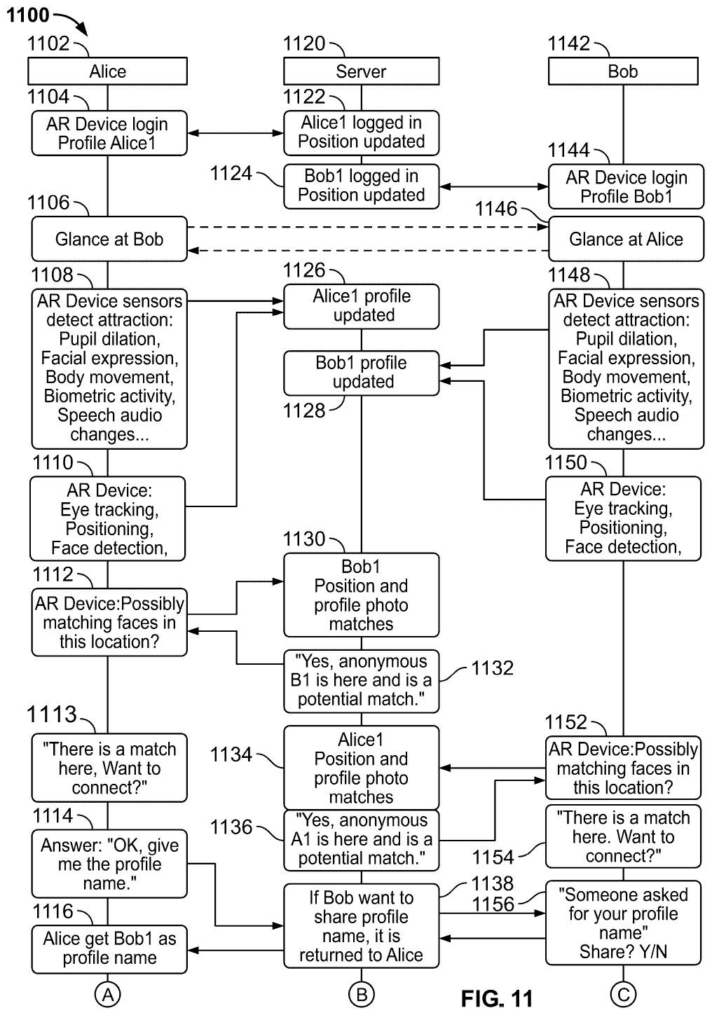

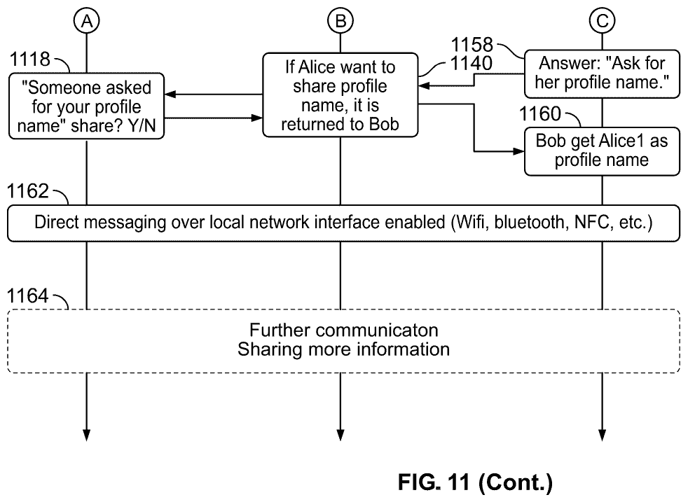

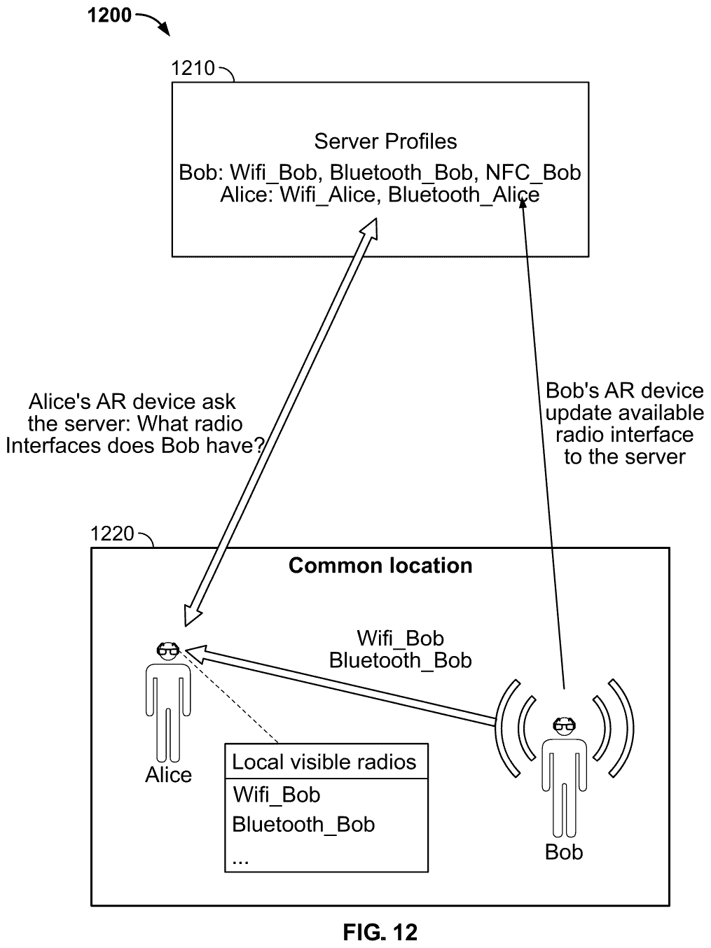

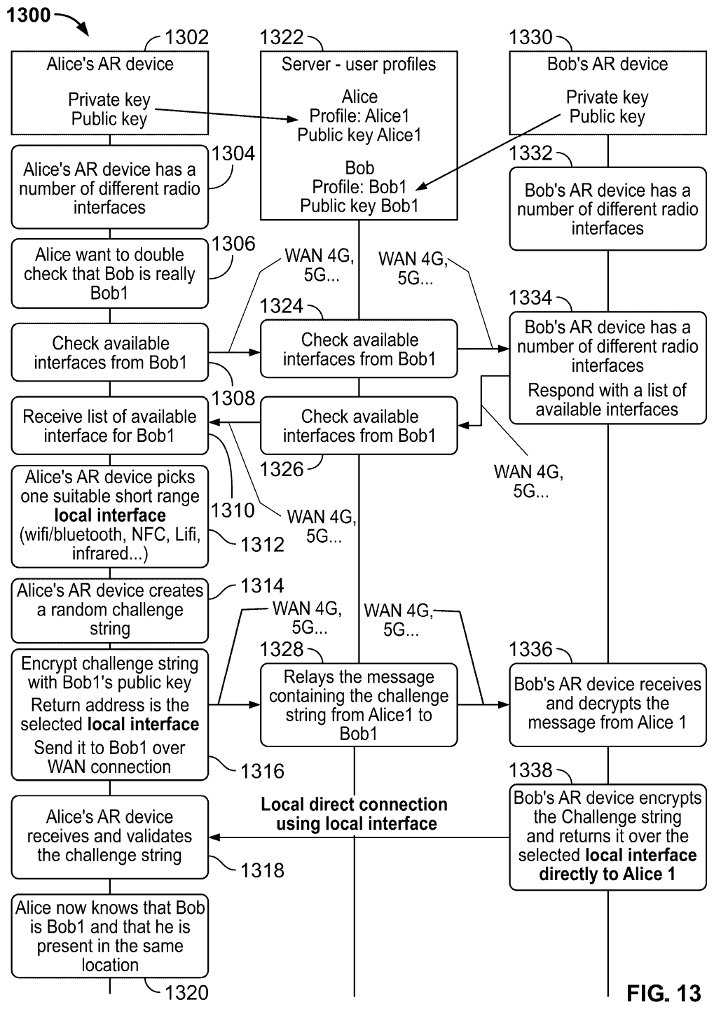

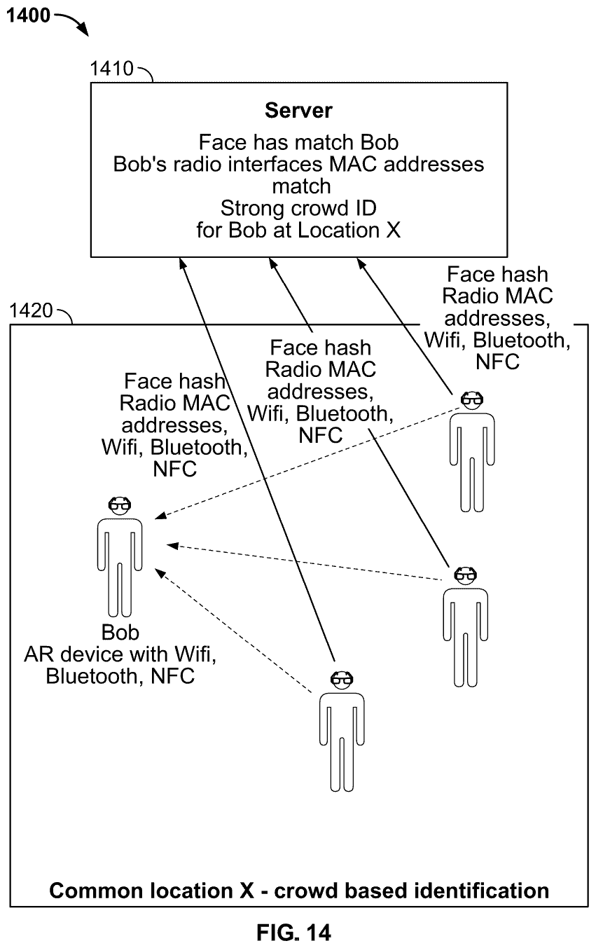

FIGS. 11 to 14 describe exemplary processes and schematics which may aid in, or be used to carry out examples of the systems and methods described herein, according to one or more embodiments. In some cases, e.g., in FIGS. 11 to 14, the first user 110, 220 may correspond to Alice and the second user 114, 214 may correspond to Bob. Alternatively, in some cases, in FIGS. 11 to 14, the first user 110, 210 may correspond to Bob and the second user 114, 214 may correspond to Alice.

Turning now to examples of the implementation of the systems and methods described herein, in a first example the first user 110 has agreed to go on a blind date in an unfamiliar city. Fortunately both the first user 110 and the second user 114 (their blind date) are members of the same dating service. Because of this, it becomes possible for the first user's 110 XR headset to help confirm on multiple levels that the second user 114 is physically at the location they have agreed upon, and that the person she eventually meets is, indeed, the second user 114.

In an exemplary scenario, before entering the unfamiliar location to meet the second user 114, the first user 110 enables within the dating application the ‘Enable digital information sharing with another subscriber’ option. Because the second user 114 has recently done the same, the service is quickly able to confirm to each of them that they are both currently present within the same area. As the first user 110 enters the location and scans the room the second user 114, the first user's 110 XR headset detect both the electromagnetic and audio environment surrounding them. Comparing this information with a de-sensitized version of the same data streaming from the second user's 114 XR headset, the first user 110 is able to quickly receive confirmation that the second user 114 is, indeed physically within this same room, and appears to be in front of her, and to her left. As the first user 110 moves in this direction, the second user 114 also receives confirmation that the first user 110 is in the same location and is able to move forward to the first user 110 as well.

Once they are in visual contact, each of first and second user's 110, 114 XR headsets are able to confirm that the person wearing the XR headsets are, indeed, the specific dating service subscribers, the first user 110 and the second user 114, that each were hoping to, and expected to meet.

Additional security measures which could be added to this example could include methods for digital confirmation by both the first user 110 and the second user 114 of any intention to progress the relationship to another level and/or confirmation and agreement to leave the current location and to travel further to another location. Furthermore, the dating platform could be given permission to record and share the streaming location information of the first user 110 and/or the second user 114 with appropriately defined and vetted ‘guardian angels’/safety services who could discreetly monitor appropriate levels of information for the duration of the first and second user's 110, 114 upgraded date.

The following day, the totality of information collected both from the first and second user's 110, 114 XR headsets, as well as from a multiplicity of other sources, could be analyzed and synthesized into compatibility and safety assessments for both the first user 110 and second user 114. During the coming days, both users 110, 114 could edit and/or fully confirm the dating assessments. Once the assessments are fully accepted, they could result in updates/adjustments to both users' 110, 114 specific compatibility ratings with each other as well as updates/adjustments to both users' 110, 114 global partner safety/dependability ratings (a measure of how safe people generally feel around the person and of how dependable they have been in the past to follow through on the things they have said).

In another example, before entering the agreed-upon location to meet, both users 110, 114 enable within the dating application the ‘Enable digital breadcrumbs’ option. Once this service is active, the first user's 110 XR headsets scan the visual, electromagnetic and audio environments surrounding them. Combined with their GPS location, the service is able to positively confirm that the first user 110 is presently near the front entrance of their favorite cocktail bar. A de-sensitized snapshot and timestamp of the location's entrance are recorded as the evening's first digital breadcrumb. Additional snapshots may be recorded and time-stamped, correlating with every major location and speaking-partner change the first user 110 makes until the service times out, or is turned off.

Depending on the first user's 110 specific settings, more or less information may be stored with each breadcrumb, and the breadcrumbs may be saved more or less often.

An extension of this concept may include the ability for the first user's 110 XR headset to automatically request permission to store additional personal/profile information from each person they speak with for more than 5 minutes that is not already known to them.

A completely new service this capability may enable is ‘Social Digital Scrapbooking’, where relevant details of all of the user's 110 encounters may be recorded for later review, enhancement and embellishment by the user 110 and their best friends. Years later, they meet to compare notes and reminisce over the people they met, got to know and dated during college and, eventually for one of their friends, marry.

In another example, reputation information may be used to improve the quality of matches. In this example, a user's 110, 114 profile may collect a reputation score based on reviews from other users 110, 114 that has dated them. By adding biometrical data together with the reputation score, a wider set of information can be collected. The biometrical data should come from the period of the date.

In a further example, a ‘social graph’ may be used to determine how many friends/associates have dated or interacted with the user 110, 114 in question. Even if attraction is not mutual, the interest in a user 110, 114 may be added to a profile to find better matches in the future. If a further user is interested in the first user 110, but the first user 110 is not interested in the further user, the first user's 110 looks, behavior and biometrics data can be stored into the profile of the further user.

By searching the social graph of the further user, other users 110, 114 that have a lot in common with the first user 110 may be recommended from their social network, friends-of-friends and similar.

Since biometric sensors and accelerometers log the data, more than just interest and looks can be matched. Active lifestyles, dancing, running, walking etc can be detected, matched and recorded.

In another example, automated levels of information sharing based on progression of the relationship's status may be used. By tracking biometric data and location over time, a progression timeline can be created. Does a pair of users 110, 114 meet a lot at the same location? Do they smile, get excited, look at each other a lot, detected by biometric data, eye tracking and the like? Do they speak with each other a lot such that audio sync, dialogue is detected? All this data can be added into the dating profiles on the dating server, as long as they have active profiles on the dating service. The collected information may be used further to refine the matching of future contacts.

In another example, a user profile ID confirmation may be carried out via audio timeline synchronization. In a scenario, a first microphone associated with a first user 110 is picking up the same as a second microphone associated with a second user 114. This may indicate that both users are in the same geographical location. Third party validation using audio hashing may be used to get a neutral check. This example may be combined with crowd sourced information (e.g., other users 222). Multiple XR headsets located in the same location can pick up the same audio (with different strengths). By using this, local third-party validation can be implemented, or even a majority vote on what the audio is at this location.

Another example may include the detection of geographical location using radio. By using Bluetooth, WiFi, NFC, and other local radio technologies, direct contact can be made to strengthen the protection against spoofing and faking identities.

Scanning each user's 110, 114 device may give a view over the locally available networks and devices, and if both users 110, 114 sees the same (or very similar) set of networks and devices, it strengthens the case that they both are in the same location. Crowd souring information as described above may further inform both parties of the visible local radio networks.

Bluetooth device names, Wifi SSIDs and similar can be used as part of the radio detection, and as an extension, radio signal strength of each network provides even more information.

Another example may utilize a challenge response for additional localized security. In such an example, a secure initial message verification may be carried out. PKI: the first user 110 wants to check if the second user 114 is really the second user 114. The first user's 110 device may create a document and may then send it over the network connection, addressed to the second user's 114 profile. The network server sends the first user's 110 document to the second user 114, again using the network connection.

The second user's 114 XR headset may cryptographically sign the first user's 110 document and sends it directly to the first user 110, using the return interface address that the document contains. The return interface address may be a local direct connection (Bluetooth, WiFi, NFC or something similar). The first user 110 may receive the signed document and can verify the contents using their private key.

In an example which may build on the above challenge response, direct messaging may be carried out using verified secured parties. That described above may be used to initiate a direct connection in both directions for direct messaging. Since PKI is available, all messages can optionally be encrypted. In this example, the document that the first user 110 sends is their direct message for the second user 114, with the return interface address as metadata in the document as well.

Another example may employ heat mapping, that is to say detecting glances over time. AR eye-tracking and aggregation of camera data from XR headset in the same location may be used to create a heat map of which user 110, 114 gains most glances. Matched with biometric arousal detection, which may include pupil dilation, increased pulse etc., an attractiveness/interest map may be created in a location.

In a further example, local, relative, popularity status may be determined by crowded sourced interest. For example, if a famous person enters the location, everyone looks over more or less at the same time. A popularity score may be built based on how many people are directing their attention to a user 110, 114.

Another example may utilize group chat for users 110, 114 in the same approximate location. By using location data and profile settings, automated group chats can be created automatically. Using the reputation crowd sourcing and PKI challenges, all participants profile information can be verified for more secure contacts within the chat group.

Double blind devices may be used in some examples. Mutual interest between two users which both have anonymity turned on is possible as well. The server may anonymize messaging between the devices and all communication must use the network link to maintain the anonymity. This may enable an anonymous user to share any profile data without revealing any identity. Sending a photo or image, or media item, may be possible without telling the other party who you are. By using the challenge response or secure messaging described above, the double-blind communication may transfer into a verified profiles communication, when the users 110, 114 want to connect closer.

Face detection from AR cameras combined with matching against profile photos and XR headset geographical location may be used to create the initial contact. Common audio feeds picked up by the AR devices microphones may also be used to tie two users 110, 114 to the same location.

The systems and processes discussed above are intended to be illustrative and not limiting. One skilled in the art would appreciate that the actions of the processes discussed herein may be omitted, modified, combined, and/or rearranged, and additional actions may be performed without departing from the scope of the disclosure. More generally, the above disclosure is meant to be exemplary and not limiting. Only the claims that follow are meant to set bounds as to what the disclosed embodiments include. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods. In this specification, the following terms may be understood given the below explanations:

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent or similar purpose unless expressly stated otherwise. Thus, unless expressly stated otherwise, each feature disclosed is one example only of a generic series of equivalent or similar features.

The disclosed techniques are not restricted to the details of the foregoing embodiments. Claimable subject matter extends to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract, and drawings), and/or all of the steps of any method or process so disclosed, may be combined in any combination, except combinations where at least some of such features and/or steps are mutually exclusive.

The reader's attention is directed to all papers and documents which are filed concurrently with or previous to this specification in connection with this application and which are open to public inspection with this specification, and the contents of all such papers and documents are incorporated herein by reference.

1. A method of controlling a user device, the method comprising:
obtaining, via an extended reality (XR) headset, a biometric response of a first user;
determining, based on obtained location data, a location of the first user;
obtaining, via a user device associated with a second user, a location of the second user;
determining, using control circuitry, that the first user and the second user are co-located based on the location of the first user and the location of the second user;
responsive to determining the first user and the second user are co-located, determining, using control circuitry, a particular interest of the first user based on the biometric response of the first user; and
generating, using control circuitry and based on determining the particular interest, a user notification indicating a presence of the first user.

2. The method according to claim 1, wherein the location of the first user and the location of the second user each comprise GPS data and/or wireless network data, and wherein determining that the first user and second user are co-located comprises:
comparing, using control circuitry, the location of the second user to the location of the first user; and
verifying, using control circuitry, that the first user and the second user are co-located when the location of the second user and the location of the first user substantially correspond.

3. The method according to claim 1, wherein the location of the first user and the location of the second user each comprise auditory data and/or photographic data, and wherein determining that the first user and second user are co-located comprises:
comparing, using control circuitry, the location of the second user to the location of the first user; and
verifying, using control circuitry, that the first user and the second user are co-located when the location of the second user and the location of the first user substantially correspond.

4. The method according to claim 1, wherein the method further comprises:
obtaining other profile data associated with another user of a corresponding other user device, wherein:
the other profile data comprises a location of the other user, and
the other user is a different user to the first user and the second user;
comparing, using control circuitry, the location of the other user to the location of the first user and the location of the second user to determine that the location of the other user substantially corresponds to the location of the first user and the location of the second user and that the other user is co-located with the first and second users; and
verifying, using control circuitry, that the first user and the second user are co-located in response to determining that the other user is co-located with the first and second users.

5. The method according to claim 1, wherein the method further comprises:
obtaining profile data associated with the second user, the profile data comprising the location of the second user.

6. The method according to claim 5, wherein the profile data associated with the second user further comprises identification data associated with the second user, and the method further comprises:
obtaining, from an environment in which the first user is located, situational data;
comparing, using control circuitry, the identification data associated with the second user to the situational data; and
verifying, using control circuitry, an identity of the second user when the identification data associated with the second user and the situational data substantially correspond.

7. The method according to claim 6, wherein the identification data associated with the second user and/or the situational data each comprise at least one of: biometric data, wireless network data, auditory data, or photographic data.

8. The method according to claim 6, wherein the method further comprises:
obtaining other profile data associated with another user of a corresponding other user device, wherein:
the other profile data comprises identification data associated with the other user, and
the other user is a different user to the first user and the second user.
comparing, using control circuitry, the situational data to the identification data associated with the other user and the identification data associated with the second user; and
verifying, using control circuitry, the identity of the second user when the situational data substantially corresponds to the identification data associated with the other user and the identification data associated with the second user.

9. The method according to claim 1, wherein determining the particular interest of the first user comprises:
comparing, using control circuitry, the biometric response of the first user to a threshold; and
identifying, using control circuitry, the particular interest if the biometric response meets the threshold.

10. The method according to claim 1, wherein the method further comprises:
determining, using control circuitry, a distance between the first user and the second user based on the location of the first user and the location of the second user;
determining, using the control circuitry, if the first user is within a predetermined distance of the second user based on the determined distance; and
only upon determining the first user is located within a predetermined distance of the second user, determining, using control circuitry, the particular interest of the first user.

11. The method according to claim 1, wherein:
the particular interest of the first user indicates the first user is attracted to the second user based on the biometric response of the first user; and
the user notification further indicates the first user is attracted to the second user.

12. The method according to claim 11, wherein the method further comprises:
transmitting to the user device associated with the second user, using control circuitry, the user notification indicating the presence of the first user and indicating the first user is attracted to the second user.

13. A system for controlling a user device, the system comprising control circuitry configured to:
obtain, via an extended reality (XR) headset, a biometric response of a first user;
determine, based on obtained location data, a location of the first user;
obtain, via a user device associated with a second user, a location of the second user;
determine that the first user and the second user are co-located based on the location of the first user and the location of the second user;
responsive to the first user and the second user being determined as co-located, determine a particular interest of the first user based on the biometric response of the first user; and
generate, based on determining the particular interest, a user notification indicating a presence of the first user.

14. The system according to claim 13, wherein the location of the first user and the location of the second user each comprise GPS data and/or wireless network data, and wherein the control circuitry is further configured to:
compare the location of the second user to the location of the first user; and
verify that the first user and the second user are co-located when the location of the second user and the location of the first user substantially correspond.

15. The system according to claim 13, wherein the location of the first user and the location of the second user each comprise auditory data and/or photographic data, and wherein the control circuitry is further configured to:
compare the location of the second user to the location of the first user; and
verify that the first user and the second user are co-located when the location of the second user and the location of the first user substantially correspond.

16. The system according to claim 13, wherein the control circuitry is further configured to:
obtain other profile data associated with another user of a corresponding other user device, wherein:
the other profile data comprises a location of the other user, and
the other user is a different user to the first user and the second user.
compare the location of the other user to the location of the first user and the location of the second user to determine that the location of the other user substantially corresponds to the location of the first user and the location of the second user and that the other user is co-located with the first and second users; and
verify that the first user and the second user are co-located in response to
determining that the other user is co-located with the first and second users.

17. The system according to claim 13, wherein the control circuitry is further configured to:
obtain profile data associated with the second user, the profile data comprising the location of the second user.

18. The system according to claim 17, wherein the profile data associated with the second user further comprises identification data associated with the second user, and the control circuitry is further configured to:
obtain, from an environment in which the first user is located, situational data;
compare the identification data associated with the second user to the situational data; and
verify an identity of the second user when the identification data associated with the second user and the situational data substantially correspond.

19. The system according to claim 18, wherein the identification data associated with the second user and/or the situational data each comprise at least one of: biometric data, wireless network data, auditory data, or photographic data.

20. The system according to claim 18, wherein the control circuitry is further configured to:
obtain other profile data associated with another user of a corresponding other user device, wherein:
the other profile data comprises identification data associated with the other user, and
the other user is a different user to the first user and the second user.
compare the situational data to the identification data associated with the other user and the identification data associated with the second user; and
verify the identity of the second user when the situational data substantially corresponds to the identification data associated with the other user and the identification data associated with the second user.

21.-60. (canceled)
